(19) United States
(12) Patent Application Publication
(10) Pub. No.: US 2010/0246417 A1
(43) Pub. Date: Sep. 30, 2010

(54) METHOD FOR SELECTING ATTACHMENT POINTS AND RELAY NODE USED IN THE METHOD

(75) Inventors: Hong Cheng, Singapore (SG); Takako Hori, Kanagawa (JP); Toyoki Ue, Kanagawa (JP); Shivanajay Marwaha, Singapore (SG)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/295,030

(22) PCT Filed: Apr. 2, 2007
(86) PCT No.: PCT/JP2007/057795

§ 371 Date: Sep. 29, 2008

(30) Foreign Application Priority Data
Mar. 31, 2006 (JP) 2006-101085
Sep. 15, 2006 (JP) 2006-251818
Jan. 26, 2007 (JP) 2007-016563

(51) Int. Cl. H04B 7/14; H04L 12/26

(52) U.S. Cl. 370/252; 370/315

(57) ABSTRACT

A technique is disclosed, according to which communication can be achieved with high efficiency by selecting access points to be connected based on the quality of end-to-end communication between a mobile node and a correspondent node when there are a plurality of access points. According to this technique, a mobile node 100 transmits to the access point a first message to request the selection of access points to be connected, and the access point, upon receipt of the first message, transmits a second message including specified information necessary for the selection of access points to be connected to a communication apparatus 108. A relay node, upon receipt of said message, updates the specified information based on a providable QoS information, transfers the updated second message to the communication apparatus, and in case another second message has been received subsequently and the relay node itself is a crossover node, optimal communication path between the mobile node and the communication apparatus is decided, and a third message is transmitted to notify the results of decision to the access point on the optimal communication path.

### TECHNICAL FIELD

The present invention relates to a method for selecting attachment points when there are a plurality of attachment points of a mobile node, which performs communication with a correspondent node via wireless communication, and the invention also relates to a relay node used in the method.

### BACKGROUND ART

With the rapid development and distribution of wireless access network, a mobile terminal (also called mobile node (MN)) encounters sometimes an environment where a plurality of access points (APs) can be used. For example, in shopping malls, several hot spots of wireless local area network (WLAN) overlapped on each other are offered for coffee shops and fast-food chain stores. Because multi-access technology is used, access can be found, which can be used in cellular network or in WLAN on the same spot. These networks or access technologies different from each other supply different types of quality of service (QoS) to users. These are based on different path conditions in different system or on different plans, which users have on different access networks. Therefore, for a terminal to initiate communication session, it is necessary to select the network or to select the interface. The selection of the network or the interface is in fact determined by QoS to the terminal.

QoS metrics in normal network selecting method is normally based on hop information at the initiation of communication. For instance, in case an AP on WLAN has an access rate of 36 Mbps and another AP has an access rate of 11 Mbps, the AP with 36 Mbps is selected. However, such simple selection does not adequately reflect actual End-to-End (E2E) QoS, which the terminal obtains after the connection. This is because E2E QoS is more easily influenced by the network element than wireless access. When an AP with 36 Mbps is connected to an upstream link (uplink) with 128 Kbps, and an AP with 11 Mbps is connected to an uplink of 1.5 Mbps, the selection of the former AP is apparently not very good.

Therefore, in order to give due consideration on E2E QoS in the network selection, it has been proposed in several solution methods to compare QoS characteristics of different paths before making the selection. For instance, it is disclosed in the Patent Document 1 as given below.

Patent Document 1: US Patent Application 2004/0228304A1 “QoS-aware handover procedure for IP-based mobile ad-hoc network environments”

Non-Patent Document 1: T. Sanda, T. Ue and T. Aramaki, “A proposal for seamless QoS support in mobile networks”, IEICE MoMuC SG, Vol. 104 No. 38, pp 59-64, May 2004

Non-Patent Document 2: R. Hancock, “Next Steps in Signaling: Framework”, RFC4080, June 2005

Non-Patent Document 3: IEEE802.21 Media Independent Handover Interoperability http://www.ieee802.org/21

Non-Patent Document 4: S. Van Den Bosch et al., “NSLP for Quality-of-Service Signaling”, Internet Draft:work in progress, February 2005, http://www.ietf.org/internet-drafts/draft-ietf-nsis-qos-nslp-06.txt

However, these are normally dependent on IP layer protocol support. These are not adequate for the selection of network in such cases where the mobile terminal must decide the network or the interface early. In order to build up an IP layer connection, there must be processes of giving and taking of some messages to and from the network. The processes of giving and taking include the steps such as authentication, authorization, allocation of IP addresses. These processes require relatively long time to attain the complete buildup, and more charges by be involved. Therefore, there are many overheads for the terminal. Another problem of the processes is that strict method with round trip signaling must be accompanied in each of the potential paths. This is extremely slow and it is delayed particularly when one of the paths has long signaling delay.

Another solution method disclosed in the Non-Patent Document 1 as given above is to transfer the signaling toward CRN (crossover node) on a different path. In this solution, the results of discovery are sent back to the mobile terminal, and the decision is made there. For the wireless terminal, the signaling takes precious bandwidth. In particular, when signaling contains various types of data such as QoS parameters of the path or data for setting of the path, many wireless resources are consumed for transmission. On the other hand, the mobile terminal normally has limited calculating ability and limited battery capacity. To enforce the calculation for selection at the terminal means that stress is applied on the terminal resources. It is obvious the above problems call for a better solution for the mobile terminal network selection.

### DISCLOSURE OF THE INVENTION

It is an object of the present invention to provide a method for selecting attachment points and a relay node used in the method, by which it is possible to achieve communication with high efficiency by selecting access points to connect based on the quality of end-to-end communication between a mobile terminal and a correspondent node in case there are a plurality of access points.

It is another object of the present invention to establish a dedicated communication connection and to execute calculation of comparison at the mobile terminal without requesting it to the mobile terminal.

As an aspect in broader sense, the present invention proposes a system to control mobile terminal communication in a data communication network, which comprises one or more SANs (Signaling Aware Node) (also called relay node), and one or more points of attachment (PoAs) (also called access point) which can provide network access to mobile terminal (MT) (also called mobile node (MN)). One of SANs selects PoA at MT to establish the communication.

In a preferred aspect of the invention, SAN is a general node on data path between all of PoAs and CNs (correspondent nodes).

In another aspect of the invention, the criteria used for the selection of PoA are included in QoS metrics.

In a more preferred aspect of the invention, CN or a specified PoA (main PoA) acts as a SAN to select PoA at MT.

To attain the above objects, the present invention provides a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises a step where said mobile node transmits a first message to request the selection of said access point to be connected by said mobile node to each of said access points to become candidates of the connection, a step where said access point transmits, upon receipt of said first message, a second message including a specified information necessary for the selection of said access point to be connected by said mobile node to said communication apparatus; and said relay node, upon receipt of said second message, updates said specified information contained in said second message based on QoS level providable by said relay node and stores said updated information in a specified storage area, transfers the updated second message to said communication apparatus, and in case a second message, transmitted by an access point different from said access point transmitting said second message received previously, has been received, it is judged whether or not the relay node itself is a crossover node to converge all of said second messages based on said specified information of said received second message, and in case it is judged that it is said crossover node, said relay node determines an optimal path between said mobile node and said communication apparatus based on said specified information stored in said specified storage area and on said specified information of said second message received currently, and transmits a third message to notify that it is the optimal communication path to said access points on said optimal communication path. With such arrangement, communication with high efficiency can be achieved by selecting access points to connect based on the quality of end-to-end communication between a mobile node and a correspondent node when there are a plurality of access points.

Also, the present invention provides, in a preferred aspect of the invention, the method for selecting attachment points as described above, wherein said first message contains at least address information of said communication apparatus, information of session ID generated by said mobile node or information to generate session ID at an access point of transmission destination of said first message, and information on number of said access points to become candidates of said connection. With such arrangement, it is possible to arrange that the mobile node can easily select the access points to be connected.

Further, the present invention provides, in a preferred aspect of the invention, the method for selecting attachment points as described above, wherein said specified information contained in said second message comprises at least information of said session ID, information of flow ID generated according to address information of said access point to transmit said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path. With such arrangement, it is possible to arrange that the mobile node can easily select the access points to be connected.

Also, the present invention provides, in a preferred aspect of the invention, the method for selecting attachment points as described above, wherein said relay node stores in said specified storage area, after the information to indicate said QoS information of said specified information contained in said second message has been updated, at least information of said session ID contained in said second message, information to indicate QoS information providable from said access point to said relay node, information to provide a path to correspond to the information to indicate said QoS information, information on number of access points transmitting said second message, contained in said second message, and information on number of said second messages with the same session ID but different flow ID. With such arrangement, it is possible to arrange that the mobile node can easily select the access points to be connected.

Further, the present invention provides, in a preferred aspect of the invention, the method for selecting attachment points as described above, wherein said relay node judges whether the relay node itself is said crossover node or not based on information of said session ID stored in said specified storage area and on information of session ID included in said second message received currently. With such arrangement, it is possible to prevent transmission of useless messages.

Also, the present invention provides, in a preferred aspect of the invention, the method for selecting attachment points as described above, wherein said method is to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises a step where said mobile node transmits a first message to request the selection of said access point to be connected by the mobile node to each of said access points to become candidates of the connection, a step where a specified access point among said access points to become candidates of said connection transmits, upon receipt of said first message, a second message to request the transmission of a third message including a specified information necessary for selection of said access point to be connected by said mobile node, a step where said communication apparatus, upon receipt of said second message, transmits said third message to each of said access points to become candidates of said connection of said mobile node, and said relay node, upon receipt of said third message, updates said specified information included in said third message based on QoS level providable by itself and stores said updated information to a specified storage area, transfers said updated third message to said access point to become candidate of said connection, and in case a third message transmitted to a transmission destination different from the transmission destination of said third message previously received is received subsequently, said relay node judges whether or not said relay node itself is a crossover node having passed all of said third messages and having branching of the path according to said specified information of said received third message, and in case said relay node judges, said relay node receives said crossover node, said relay node receives each of said specified types of information of said third message from said access points to be candidates of said connection of said mobile node of transmission destination of said third message, determines an optimal path between said mobile node and said communication apparatus based on these types of information, and transmits a fourth message to notify that it is the optimal communication path to said access point on said optimal communication path. With such arrangement, communication with high efficiency can be achieved by selecting access points connect based on the quality of end-to-end communication between a mobile node and a correspondent node in case there are a plurality of access points.

Further, the present invention provides, in a preferred aspect of the invention, the method for selecting attachment points as described above, wherein said first message contains at least address information of said communication apparatus, information of session ID generated by said mobile node, or information to generate session ID at access point of transmission destination of said first message, and information on number of said access points to become candidates of said connection. With such arrangement, it is possible to arrange that the mobile node can easily select the access points to be connected.

Also, the present invention provides, in a preferred aspect of the invention, the method for selecting attachment points as described above, wherein said second message contains at least information of flow ID generated according to the address information of said access point to become candidates of said connection, and information on number of said access points to become candidates of said connection. With such arrangement, it is possible to arrange that the mobile node can easily select the access points to be connected.

Further, the present invention provides, in a preferred aspect of the invention, the method for selecting attachment points as described above, wherein said specified information contained in said third message comprises at least information of said session ID, information of said flow ID generated according to address information of said access point of transmission destination of said third message, information to indicate a request to select an optimal communication path between said mobile node and said communication apparatus, information on number of said access points to transmit said third message, information used when said mobile node selects said access point to be connected, and information to indicate QoS information as updatable at said relay node on the path where said third message passes and providable on said path. With such arrangement, it is possible to arrange that the mobile node can easily select the access points to be connected.

Also, the present invention provides, in a preferred aspect of the invention, the method for selecting attachment points as described above, wherein said relay node stores in said specified storage area, after the information to indicate said QoS information of said specified information contained in said third message has been updated, at least information of said session ID contained in said third message, information to indicate QoS information providable from said access point to said relay node, information to provide a path to correspond to the information to indicate said QoS information, information on number of access points transmitting said third message, contained in said third message, and information on number of said third messages with the same session ID but different flow ID. With such arrangement, it is possible to arrange that the mobile node can easily select the access points to be connected.

Further, the present invention provides, in a preferred aspect of the invention, the method for selecting attachment points as described above, wherein said relay node judges whether or not the relay node itself is said crossover node based on information of said session ID stored in said specified storage area and also based on information of session ID included in said third message received currently. With such arrangement, it is possible to prevent transmission of useless messages.

Also, the present invention provides, in a preferred aspect of the invention, the method for selecting attachment points as described above, wherein said method us to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises a step where said mobile node transmits a first message to request the selection of said access point to be connected by said mobile node to each of said access points to become candidates of the connection, a step where said access point, upon receipt of said first message, transmits a second message including specified information necessary for selection of said access point to be connected by said mobile node to said communication apparatus, a step where said relay node, upon receipt of said second message, updates said specified information contained in said second message based on QoS level providable by the relay node and transfers said updated second message to said communication apparatus, a step where said communication apparatus, upon receipt of said second message updated by said relay node, determines the optimal communication path between said mobile node and said communication apparatus based on said specified information contained in all of said received second messages and notifies that it is the optimal communication path to said access points on said optimal communication path. With such arrangement, communication with high efficiency can be achieved by selecting access points connect based on the quality of end-to-end communication between a mobile node and a correspondent node in case there are a plurality of access points.

Further, the present invention provides, in a preferred aspect of the invention, the method for selecting attachment points as described above, wherein said first message contains at least address information of said communication apparatus, information of session ID generated by said mobile node or information to generate session ID at an access point of transmission destination of said first message, and information on number of said access points to become candidates of said connection. With such arrangement, it is possible to arrange that the mobile node can easily select the access points to be connected.

Also, the present invention provides, in a preferred aspect of the invention, the method for selecting attachment points as described above, wherein said specified information contained in said second message comprises at least information of said session ID and information of flow ID generated according to address information of said access point to transmit said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path. With such arrangement, it is possible to arrange that the mobile node can easily select the access points to be connected.

Further, the present invention provides, in a preferred aspect of the invention, the method for selecting attachment points as described above, wherein said method is to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises a step where said mobile node transmits a first message to request the selection of said access point to be connected by said mobile node to each of said access points to become candidates of the connection, a step where a specified access point among said access points to become candidates of said connection, upon receipt of said first message transmits a second message to request to transmit a third message containing a specified information necessary for selection of said access point to be connected by said mobile node, a step where said communication apparatus, upon receipt of said second message, transmits said third message to each of said access points to become candidates of said connection of said mobile node, a step where said relay node, upon receipt of said third message updates said specified information contained in said third message based on QoS level providable by said relay node and transfers said updated third message to said access point to become candidate of said connection, a step where each of said access points, upon receipt of said third message updated by said relay node, transmits a fourth message containing said specified information included in said received third message to said communication apparatus, a step where said communication apparatus, upon receipt of said fourth message, determines an optimal communication path between said mobile node and said communication apparatus based on said specified information of said fourth message and transmits a fifth message to notify that it is the optimal communication path to said access point on said optimal communication path. With such arrangement, communication with high efficiency can be achieved by selecting access points connect based on the quality of end-to-end communication between a mobile node and a correspondent node in case there are a plurality of access points.

Also, the present invention provides, in a preferred aspect of the invention, the method for selecting attachment points as described above, wherein said first message contains at least address information of said communication apparatus, information of session ID generated by said mobile node, or information to generate session ID at an access point of transmission destination of said first message, and information on number of said access points to become candidates of said connection. With such arrangement, it is possible to arrange that the mobile node can easily select the access points to be connected.

Further, the present invention provides, in a preferred aspect of the invention, the method for selecting attachment points as described above, wherein said second message contains at least information of flow ID generated according to address information of said access points to become candidates of said connection, and information number of said access points to become candidates of said connection. With such arrangement, it is possible to arrange that the mobile node can easily select the access points to be connected.

Also, the present invention provides, in a preferred aspect of the invention, the method for selecting attachment points as described above, wherein said specified information contained in said third message comprises at least information of said session ID, information of flow ID generated according to address information of said access point to transmit said third message, information to indicate a request to select an optimal communication path between said mobile node and said communication apparatus, information on number of said access points to transmit said third message, information used when said mobile node selects said access point to be connected, and information to indicate QoS information as updatable at said relay node on the path where said third message passes and providable on said path. With such arrangement, it is possible to arrange that the mobile node can easily select the access points to be connected.

Further, the present invention provides, in a preferred aspect of the invention, the method for selecting attachment points as described above, wherein said method is to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises a step where said mobile node transmits a first message to request the selection of said access point to be connected by said mobile node to each of said access points to become candidates of the connection, a step where a specified access point among said access points to become candidates of said connection, upon receipt of said first message transmits a second message to request to transmit a third message containing a specified information necessary for selection of said access point to be connected by said mobile node, a step where a specified access point among said specified access points to become candidates of said connection transmits, upon receipt of said first message, a second message to request transmission of a third message including specified information necessary for selection of said access point to be connected by said mobile node, a step where said communication apparatus, upon receipt of said second message, transmits said third message to each of said access points to become candidates of said connection of said mobile node, a step where said relay node, upon receipt of said third message, updates said specified information contained in said third message based on QoS level providable by said relay node and transfers said updated third message to said access point to become candidate of said connection, a step where each of said access points transmits, upon receipt of said third message updated by said relay node, a fourth message containing said specified information included in said received third message to said specified access point, a step where said specified access point, upon receipt of said fourth message, determines an optimal communication path between said mobile node and said communication apparatus based on said specified information of said fourth message and transmits a fifth message to notify that it is the optimal communication path to said access point on said optimal communication path. With such arrangement, communication with high efficiency can be achieved by selecting access points connect based on the quality of end-to-end communication between a mobile node and a correspondent node in case there are a plurality of access points.

Also, the present invention provides, in a preferred aspect of the invention, the method for selecting attachment points as described above, wherein said first message contains at least address information of said communication apparatus, information of session ID generated by said mobile node, or information to generate session ID at an access point of transmission destination of said first message, and information on number of said access points to become candidates of said connection. With such arrangement, it is possible to arrange that the mobile node can easily select the access points to be connected.

Further, the present invention provides, in a preferred aspect of the invention, the method for selecting attachment points as described above, wherein said second message contains at least information of flow ID generated according to the address information of said access point to become candidates of said connection, and information on number of said access points to become candidates of said connection. With such arrangement, it is possible to arrange that the mobile node can easily select the access points to be connected.

Also, the present invention provides, in a preferred aspect of the invention, the method for selecting attachment points as described above, wherein said specified information contained in said third message comprises at least information of said session ID and information of flow ID generated according to address information of said access point to transmit said third message, information to indicate a request to select an optimal communication path between said mobile node and said communication apparatus, information on number of said access points to transmit said third message, information used when said mobile node selects said access point to be connected, and information to indicate QoS information as updatable at said relay node on the path where said third message passes and providable on said path. With such arrangement, it is possible to arrange that the mobile node can easily select the access points to be connected.

Further, the present invention provides a relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said relay node comprises receiving means for receiving a second message containing a specified information necessary for selection of said access point to be connected by said mobile node based on a first message to request selection of said access point to be connected by said mobile node, updating means for updating said specified information contained in said second message received via said receiving means based on QoS level providable by said relay node itself and for storing the information in a specified storage area, transfer means for transferring said updated second message to said communication apparatus, judging means for judging whether or not the relay node itself is a crossover node to converge all of said second messages based on the second message transmitted by a transmission source different from the transmission source of said second message previously received after the transfer of said updated second message, and message generating means for determining an optimal communication path between said mobile node and said communication apparatus based on said specified information stored in said specified storage area and on said specified information of said second message received currently in case it is judged that the relay node itself is said crossover node by said judging means, and for generating a third message to notify that it is the optimal communication path to said access point on said optimal communication path.

Also, the present invention provides, in a preferred aspect of the invention, a relay node as described above, wherein said first message contains at least address information of said communication apparatus, information of session ID generated by said mobile node and information to generate session ID at an access point of transmission destination of said first message, and information on number of said access points to become candidates of said connection. With such arrangement, it is possible to arrange that the mobile node can easily select the access points to be connected.

Further, the present invention provides, in a preferred aspect of the invention, a relay node as described above, wherein said specified information contained in said second message comprises at least information of said session ID, information of flow ID generated according to address information of said access point to transmit said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path. With such arrangement, it is possible to arrange that the mobile node can easily select the access points to be connected.

Also, the present invention provides, in a preferred aspect of the invention, a relay node as described above, wherein said updating means stores in said specified storage area, after the information to indicate said QoS information of said specified information contained in said second message has been updated, at least information of said session ID contained in said second message, information to indicate QoS information providable from said access point to said relay node, information to provide a path to correspond to the information to indicate said QoS information, information on number of access points transmitting said second message, contained in said second message, and information on number of said second messages with the same session ID but different flow ID. With such arrangement, it is possible to arrange that the mobile node can easily select the access points to be connected.

Further, the present invention provides, in a preferred aspect of the invention, a relay node as described above, wherein said judging means judges whether or not the relay node itself is said crossover node or not based on information of said session ID stored in said specified storage area and on information of session ID included in said second message received currently. With such arrangement, it is possible to prevent transmission of useless message.

Also, the present invention provides a relay node as described above, wherein a relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said relay node comprises receiving means for receiving a first message including a specified information necessary for selection of said access points to be connected by said mobile node, updating means for updating said specified information contained in said first message received via said receiving means based on QoS level providable by said relay node itself, and for storing the information in a specified storage area, transfer means for transferring said updating first message to said access point to become candidate of said connection, judging means for judging whether the relay node itself is crossover node or not, where all of said first messages pass through and which has branching on the path, in case a first message with a transmission destination different from the transmission destination of said first message previously received has been received after the transfer of said updated first message, message generating means for determining the optimal communication path between said mobile node and said communication apparatus based on said specified information of said first message received respectively from said access points to become candidates of said mobile node with the transmission destination of said first message when it is judged that the relay node itself is a crossover node by said judging means, and for generating a second message to notify that it is the optimal communication path to said access point on said optimal communication path. With such arrangement, communication with high efficiency can be achieved by selecting access points connect based on the quality of end-to-end communication between a mobile node and a correspondent node in case there are a plurality of access points.

Further, the present invention provides, in a preferred aspect of the invention, a relay node as described above, wherein said specified information contained in said first message comprises at least information of said session ID, information of flow ID generated according to address information of said access point to transmit said first message, information to indicate a request to select an optimal communication path between said mobile node and said communication apparatus, information on number of said access points to transmit said first message, information used when said mobile node selects said access point to be connected, and information to indicate QoS information as updatable at said relay node on the path where said first message passes and providable on said path. With such arrangement, it is possible to arrange that the mobile node can easily select the access points to be connected.

Also, the present invention provides, in a preferred aspect of the invention, a relay node as described above, wherein said updating means stores in said specified storage area, after the information to indicate said QoS information of said specified information contained in said first message has been updated, at least information of said session ID contained in said first message, information to indicate QoS information providable from said access point to said relay node, information to provide a path to correspond to the information to indicate said QoS information, information on number of access points contained in said first message and transmitting said first message, and information on number of said first messages with the same session ID but different flow ID. With such arrangement, it is possible to arrange that the mobile node can easily select the access points to be connected.

Further, the present invention provides, in a preferred aspect of the invention, a relay node as described above, wherein said judging means judges whether the relay node itself is said crossover node or not based on information of said session ID stored in said specified storage area and on information of session ID included in said second message received currently. With such arrangement, it is possible to prevent transmission of useless messages.

Also, the present invention provides a relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said relay node comprises receiving means for receiving a second message containing a specified information necessary for selection of said access point to be connected by said mobile node based on a first message to request selection of said access point to be connected by said mobile node, updating means for updating said specified information contained in said second message received via said receiving means based on QoS level providable by said relay node itself, and transfer means for transferring said updated second message to said communication apparatus. With such arrangement, communication with high efficiency can be achieved by selecting access points connect based on the quality of end-to-end communication between a mobile node and a correspondent node in case there are a plurality of access points.

Further, the present invention provides, in a preferred aspect of the invention, a relay node as described above, wherein said first message contains at least address information of said communication apparatus, information of session ID generated by said mobile node, or information to generate session ID at an access point of transmission destination of said first message, and information on number of said access points to become candidates of said connection. With such arrangement, it is possible to arrange that the mobile node can easily select the access points to be connected.

Also, the present invention provides the relay node as described above, wherein said specified information contained in said second message comprises at least information of said session ID, information of flow ID generated according to address information of said access point to transmit said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path. With such arrangement, it is possible to arrange that the mobile node can easily select the access points to be connected.

Further, the present invention provides a relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said relay node comprises receiving means for receiving a first message containing a specified information necessary for selection of said access point to be connected by said mobile node, updating means for updating said specified information contained in said first message received via said receiving means based on QoS level providable by the relay node itself, and transfer means for transferring said updated first messages to said access point to become candidate of said connection. With such arrangement, communication with high efficiency can be achieved by selecting access points connect based on the quality of end-to-end communication between a mobile node and a correspondent node in case there are a plurality of access points.

Also, the present invention provides, in a preferred aspect of the invention, the relay node as described above, wherein said specified information contained in said first message comprises at least information of said session ID and information of flow ID generated according to address information of said access point to transmit said first message, information to indicate a request to select an optimal communication path between said mobile node and said communication apparatus, information on number of said access points to transmit said first message, information used when said mobile node selects said access point to be connected, and information to indicate QoS information as updatable at said relay node on the path where said first message passes and providable on said path. With such arrangement, it is possible to arrange that the mobile node can easily select the access points to be connected.

Further, the present invention provides a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication and having a plurality of interfaces, and one or more relay nodes positioned between said plurality of access points and said communication apparatus and capable to receive and to process the messages with a specified quality transmitted and received between said mobile node and said communication apparatus, wherein said method comprises a step where said mobile node transmits a first message to request selection of said access point to be connected by the mobile node itself to each of said access points to become candidates of connection, a step where said access point, upon receipt of said first message, transmits a second message containing a specified information necessary for selection of said access points to be connected by said mobile node to said communication apparatus, a step wherein said relay node, upon receipt of said second message, updates said specified information contained in said second message based on QoS level providable by the relay node itself and stores said updated information in a specified storage area, transfers said updated second message to said communication apparatus, and when the second message transmitted by an access point different from said access point transmitting said second message received previously is received subsequently, said relay node judges whether or not the relay node itself is a crossover node to converge said second message based on specified information of received second message, and in case it is judged as said crossover node, said relay node calculates QoS information of the optimal communication path between said mobile node and itself according to said specified information stored in said specified storage area and to said specified information of said second message received currently, and transmits a third message to acquire QoS information between itself and said communication apparatus, a step where said crossover node calculates optimal QoS information in itself based on QoS information between the crossover node itself transmitted from said communication apparatus and said communication apparatus and on the calculated QoS information on the optimal communication path between said mobile node and itself, and transmits it to said specified access point, and a step where said specified access point determines the optimal communication path based on QoS information received from a plurality of crossover nodes and notifies the access point to be connected to said mobile node. With such arrangement, communication with high efficiency can be achieved by selecting access points to connect based on the quality of end-to-end communication between a mobile node and a correspondent node when there are a plurality of access points and the communication apparatus has a plurality of interfaces.

Also, the present invention provides, in a preferred aspect of the invention, the method for selecting attachment points as described above, wherein said first message contains at least a plurality of types of address information of said communication apparatus, information of session ID generated by said mobile node, or information to generate session ID at an access point of transmission destination of said first message, information on number of said access points to become candidates of said connection, and information to indicate that said relay node performs specific operation because said communication apparatus has a plurality of interfaces. With such arrangement, it is possible to arrange that the mobile node can easily select the access points to be connected.

Further, the present invention provides, in a preferred aspect of the invention, the method for selecting attachment points as described above, wherein said specified information contained in said second message comprises at least information of said session ID and information of flow ID generated according to address information of said access point to transmit said second message, information to indicate destination of said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path. With such arrangement, it is possible to arrange that the mobile node can easily select the access points to be connected.

Also, the present invention provides, in a preferred aspect of the invention, the method for selecting attachment points as described above, wherein said relay node stores in said specified storage area, after the information to indicate said QoS information of said specified information contained in said second message has been updated, at least information of said session ID contained in said second message information to indicate destination of said second message, information to indicate QoS information providable from said access point to said relay node, information to provide a path to correspond to the information to indicate said QoS information, information of flow ID of a message to indicate that it is for selection of the path, information on number of access points contained in said second message and transmitting said second message, and information on number of said second messages with the same session ID but different flow ID. With such arrangement, it is possible to arrange that the mobile node can easily select the access points to be connected.

Further, the present invention provides, in a preferred aspect of the invention, the method for selecting attachment points as described above, wherein said relay node judges whether or not the relay node itself is said crossover node based on information of said session ID stored in said specified storage area and on information of session ID included in said second message received currently. With such arrangement, it is possible to prevent transmission of useless messages.

Also, the present invention provides the method for selecting attachment points as described above, wherein said method is to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication and having a plurality of interfaces, and one or more relay nodes positioned between said plurality of access points and said communication apparatus and capable to receive and to process the messages with a specified quality and transmitted and received between said mobile node and said communication apparatus, wherein said method comprises a transmitting step where said mobile node transmits a first message to request selection of said access point to be connected by the mobile node itself to each of the specified access points among said access points to become candidates of the connection, a transmitting step where said specified access point transmits, upon receipt of said first message, a second message to request to transmit a third message including a specified information necessary for selection of said access point to be connected by said mobile node, a transmitting step where said communication apparatus, upon receipt of said second message, transmits said third message to each of said access points to become candidates of said connection of the mobile node, a transmitting step where said relay node, upon receipt of said third message, updates said specified information contained in said third message based on QoS level providable in itself, stores updated information in a specified storage area, and transfers said updated third message to said access points to become candidates of said connection, and in case the third message from a transmission source different from the transmission source of said third message previously received is received subsequently, said relay node judges whether the relay node itself is a crossover node to converge the messages or not based on said specified information of said received third message, and in case it is judged that it is said crossover node, the relay node calculates QoS information of the optimal communication path between the communication apparatus and itself based on said specified information stored in said specified storage area and on said specified information of said third message received currently, and transmits a fourth message to acquire QoS information between the relay node itself and said mobile node, a step where said crossover node calculates the optimal QoS information on itself based on QoS information between itself transmitted from said mobile node and said mobile node and on said calculated QoS information of the optimal communication path between said communication apparatus and itself, and transmits it to said specified access point, and a step where said specified access point determines the optimal communication path based on QoS information received from a plurality of crossover nodes and notifies the access points to be connected to said mobile node. With such arrangement, communication with high efficiency can be achieved by selecting access points to connect based on the quality of end-to-end communication between a mobile node and a correspondent node when there are a plurality of access points and the communication apparatus has a plurality of interfaces.

Further, the present invention provides, in a preferred aspect of the invention, the method for selecting attachment points as described above, wherein said first message contains at least a plurality of types of address information of said communication apparatus, information of session ID generated by said mobile node, or information to generate session ID at an access point of transmission destination of said first message, information on number of said access points to become candidates of said connection, address information of said access point to become candidates of said connection, and information to indicate data flow direction. With such arrangement, it is possible to arrange that the mobile node can easily select the access points to be connected.

Also, the present invention provides the method for selecting attachment points as described above, wherein said second message contains at least a plurality of types of address information of said communication apparatus, information of session ID generated by said mobile node, or information to generate session ID to an access point of transmission destination of said first message, information on number of said access points to become candidates of said connection, and address information of said access points to become candidates of said connection. With such arrangement, it is possible to arrange that the mobile node can easily select the access points to be connected.

Further, the present invention provides, in a preferred aspect of the invention, the method for selecting attachment points as described above, wherein, when said mobile node has a plurality of interfaces, said mobile node places into said first message information to indicate that said plurality of interfaces of said communication apparatus are used or information to indicate that said plurality of interfaces of the mobile node itself are used, said access point, upon receipt of said first message, places into said second message a flag to indicate that said plurality of interfaces of said communication apparatus are used or to indicate that said plurality of interfaces of said mobile node itself are used by said mobile node, and said communication apparatus, upon receipt of said second message, places into said third message, a flag to indicate that said communication apparatus uses said plurality of interfaces of the communication apparatus itself or to indicate that said mobile node uses said plurality of interfaces of the mobile node itself. With the arrangement as described above, communication with high efficiency can be achieved by selecting access points to connect based on the quality of end-to-end communication between a mobile node and a correspondent node even when the mobile node has a plurality of interfaces.

Also, the present invention provides, in a preferred aspect of the invention, the method for selecting attachment points as described above, wherein, when said mobile node has a plurality of interfaces, said mobile node places into said first message information to indicate that said plurality of interfaces of said communication apparatus are used or information to indicate that said plurality of interfaces of the mobile node itself are used, said specified access point places, upon receipt of said first message, into said second message, information to indicate that said plurality of interfaces of said communication apparatus are used by said communication apparatus itself or said plurality of interfaces of said mobile node itself are used by said mobile node; and said communication apparatus, upon receipt of said second message, places into said third message, information to indicate that said communication apparatus uses said plurality of interfaces of the communication apparatus itself, or to indicate that said mobile node uses said plurality of interfaces of the mobile node itself. With the arrangement as described above, communication with high efficiency can be achieved by selecting access points to connect based on the quality of end-to-end communication between a mobile node and a correspondent node even when the mobile node has a plurality of interfaces.

Further, the present invention provides, in a preferred aspect of the invention, the method for selecting attachment points as described above, wherein, in case said mobile node or said access point to become candidates of connection has IP address of said mobile node in advance after the connection to said access point, it is so arranged that said optimal communication path is determined and resource reservation is made to said optimal communication path. With the arrangement as described above, it is possible to reduce the time required for processing after moving (after the handover).

Also, the present invention provides, in a preferred aspect of the invention, a relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication and having a plurality of interfaces, and one or more relay nodes positioned between said plurality of access points and said communication apparatus and capable to receive and to process the messages with a specified quality transmitted and received between said mobile node and said communication apparatus, wherein said relay node comprises receiving means for receiving a second message containing a specified information necessary for selection of said access point to be connected by said mobile node based on a first message to request selection of said access point to be connected by said mobile node, updating means for updating said specified information contained in said second message received via said receiving means based on QoS level providable by said relay node itself and storing in a specified storage area, transfer means for transferring said updated second message to said communication apparatus, judging means for judging whether or not the relay node itself is a crossover node to converge all of said second messages based on said specified information of the second message transmitted by a transmission source different from the transmission source of said second message previously received after the transfer of said updated second message; and calculating means for calculating QoS information on optimal communication path between said mobile node and said relay node itself based on said specified information stored in said specified storage area and on said specified information of said second message received currently in case the relay node itself judges that it is in itself said crossover node by said judging means, message generating means for generating a third message to acquire QoS information between said relay node itself and said communication apparatus; and said transfer means transmits said third message to said communication apparatus. With such arrangement, communication with high efficiency can be achieved by selecting access points to connect based on the quality of end-to-end communication between a mobile node and a correspondent node when there are a plurality of access points and the communication apparatus has a plurality of interfaces.

Further, the present invention provides the relay node as described above, wherein said first message contains at least a plurality of types of information of said communication apparatus, information of session ID generated by said mobile node and information to generate session ID at an access point of transmission destination of said first message, and information on number of said access points to become candidates of said connection. With such arrangement, it is possible to arrange that the mobile node can easily select the access points to be connected.

Also, the present invention provides a relay node as described above, wherein said specified information contained in said second message comprises at least information of said session ID, information of flow ID generated according to address information of said access point to transmit said second message, information to indicate destination of said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path. With such arrangement, it is possible to arrange that the mobile node can easily select the access points to be connected.

Further, the present invention provides a relay node as described above, wherein said updating means stores in said specified storage area, after the information to indicate said QoS information of said specified information contained in said second message has been updated, at least information of said session ID contained in said second message, information to indicate destination of said second message, information to indicate QoS information providable from said access point to said relay node, information to provide a path to correspond to the information to indicate said QoS information, information of flow ID of the message to indicate that it is for path selection, information on number of access points transmitting said second message contained in said second message, and information on number of said second messages with the same session ID but different flow ID. With such arrangement, it is possible to arrange that the mobile node can easily select the access points to be connected.

Also, the present invention provides the relay node as described above, wherein said judging means judges whether the relay node itself is said crossover node or not based on information of said session ID stored in said specified storage area and on information of session ID included in said second message received currently. With such arrangement, it is possible to prevent transmission of useless messages.

Further, the present invention provides a relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication and having a plurality of interfaces, and one or more relay nodes positioned between said plurality of access points and said communication apparatus and capable to receive and to process the messages with a specified quality transmitted and received between said mobile node and said communication apparatus, wherein said relay node comprises receiving means for receiving a first message containing a specified information necessary for selection of said access point to be connected by said mobile node, updating means for updating said specified information contained in said first message received via said receiving means based on QoS level providable by said relay node itself, and for storing it in a specified storage area, transfer means for transferring said updated first message to said access point to become candidate of said connection, judging means for judging whether or not the relay node itself is a crossover node to converge the message based on said specified information of said received first message in case a first message is received, which has been transmitted from a transmission source different from the transmission source of said first message received previously after the transfer of said updated first message, calculating means for calculating QoS information on the optimal communication path between said communication apparatus and the relay node itself based on said specified information stored in said specified storage area and on said specified information of said first message received currently in case it is judged by said judging means that the relay node itself is said crossover node, message generating means for generating a second message to acquire QoS information between said relay node itself and said mobile node; and said calculating means calculates optimal QoS information in said crossover node itself based on QoS information between said crossover node itself and said mobile node transmitted from said mobile node and on QoS information on the calculated optimal communication path between said communication apparatus and said crossover node itself; and said transfer means transmits results of calculation obtained by said calculating means to a specified access point. With such arrangement, communication with high efficiency can be achieved by selecting access points to connect based on the quality of end-to-end communication between a mobile node and a correspondent node when there are a plurality of access points and the communication apparatus has a plurality of interfaces.

Also, the present invention provides a relay node as described above, wherein, in case said mobile node has a plurality of interfaces, said receiving means receives said second message including a flag to indicate that said communication apparatus uses said plurality of interfaces of said communication apparatus itself, or said mobile node uses said plurality of interfaces in a second message containing a specified information necessary for selection of said access point to be connected by said mobile node based on a first message to request selection of said access point to be connected by said mobile node. With the arrangement as described above, communication with high efficiency can be achieved by selecting access points to connect based on the quality of end-to-end communication between a mobile node and a correspondent node even when the mobile node has a plurality of interfaces.

Further, the present invention provides a relay node as described above, wherein, in case said mobile node has a plurality of interfaces, said receiving means receives a first message including a flag to indicate that said communication apparatus uses said plurality of interfaces of said communication apparatus itself and or that the mobile node uses said plurality of interfaces in the first message including a specified information necessary for selection of said access point to be connected by said mobile node. With the arrangement as described above communication with high efficiency can be achieved by selecting access points to connect based on the quality of end-to-end communication between a mobile node and a correspondent node even when the mobile node has a plurality of interfaces.

The method for selecting attachment points and the relay node used in said method have the arrangement as described above.

With such arrangement, communication with high efficiency can be achieved by selecting access points to connect based on the quality of end-to-end communication between a mobile node and a correspondent node in case there are a plurality of access points.

### BRIEF DESCRIPTION OF THE DRAWINGS

FIG. 1 is a schematical block diagram to show an example of arrangement of a communication network in a first embodiment of the present invention;

FIG. 2 is a schematical block diagram to show an example of arrangement of MN in the first embodiment of the present invention;

FIG. 3 is a schematical block diagram to show an example of arrangement of an attachment point in the first embodiment of the present invention;

FIG. 4 is a schematical block diagram to show an example of arrangement of a relay node in the first embodiment of the present invention;

FIG. 5 is a sequence chart to show an example of a method for selecting connection points of MN in the first embodiment of the present invention;

FIG. 6 is a sequence chart to show an example of a method for selecting connection points of MN in a second embodiment of the present invention;

FIG. 7 is a sequence chart to show another example of a method for selecting connection points of MN in the second embodiment of the present invention;

FIG. 8 is a schematical block diagram to show an example of a communication network in each of a fifth to an eight embodiments of the present invention;

FIG. 9 is a sequence chart to show an example of a sequence to select the optimal communication path in case MN of the present invention has one or more interfaces and does not have CoA;

FIG. 10 is a sequence chart to show an example of a sequence for resource reservation to the optimal communication path in a ninth embodiment of the present invention;

FIG. 11 is a sequence chart to show an example of another sequence for resource reservation to the optimal communication path in the ninth embodiment of the present invention;

FIG. 12 is a schematical block diagram to show an example or an arrangement of a communication network in a tenth embodiment of the present invention;

FIG. 13 is a sequence chart to show an example of a method for selecting connection points of MN in the tenth embodiment of the present invention; and

FIG. 14 is a sequence chart to show another example of a method for selecting connection points of MN in the tenth embodiment of the present invention.

### BEST MODE FOR CARRYING OUT THE INVENTION

### 1st Embodiment

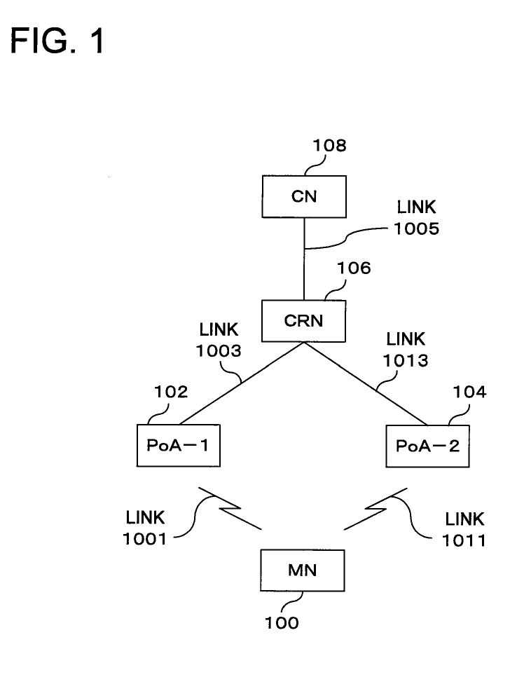

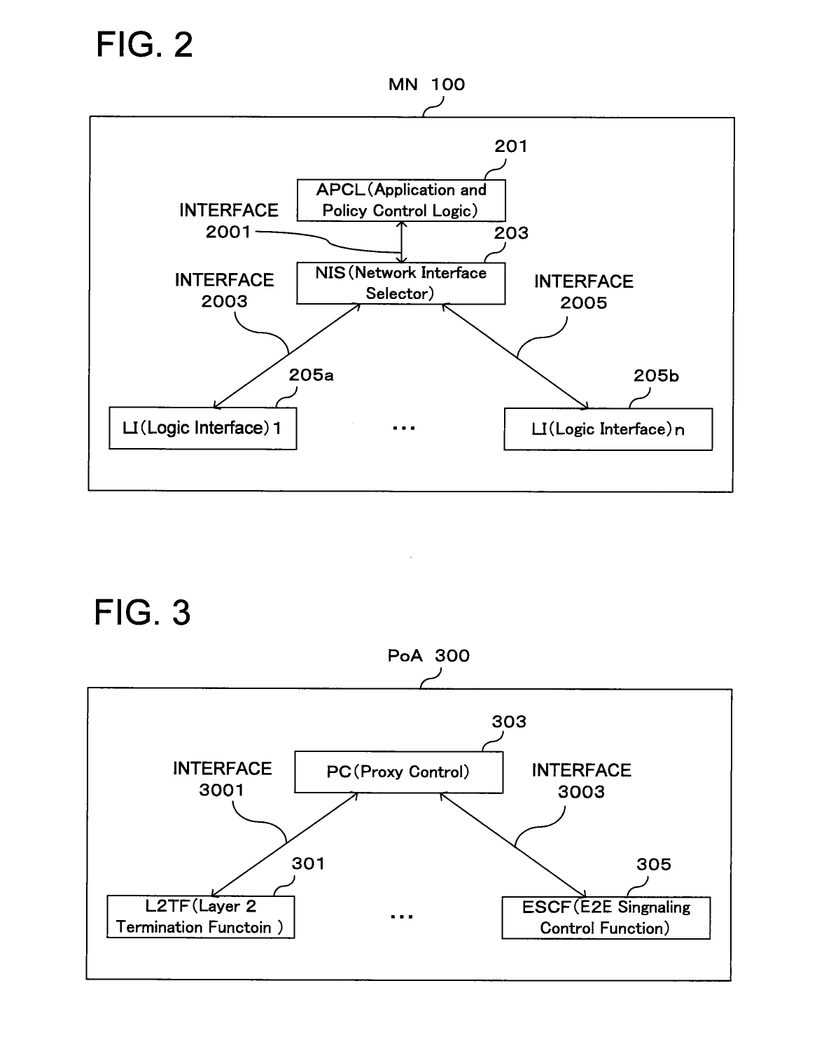

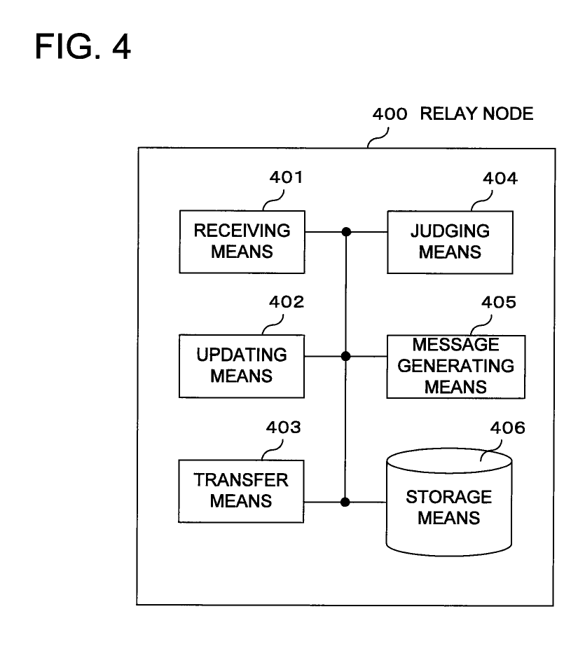

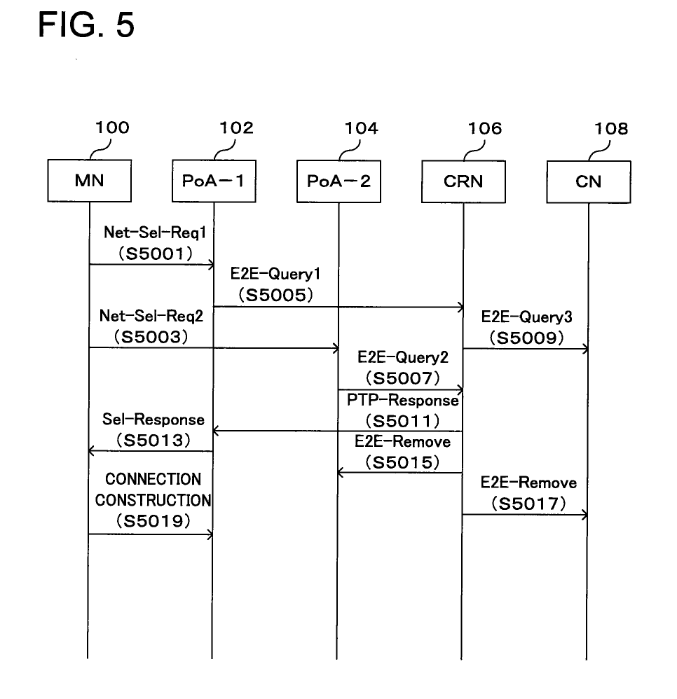

Description will be given below on a first embodiment of the invention referring to FIG. 1 to FIG. 5. FIG. 1 is a schematical block diagram to show an example of arrangement of a communication network in the first embodiment of the present invention. FIG. 2 is a schematical block diagram to show an example of arrangement of MN in the first embodiment of the present invention; FIG. 3 is a schematical block diagram to show an example of arrangement of an attachment point in the first embodiment of the present invention; FIG. 4 is a schematical block diagram to show an example of arrangement of a relay node in the first embodiment of the present invention; and FIG. 5 is a sequence chart to show an example of a method for selecting connection points of MN in the first embodiment of the present invention;

First, referring to FIG. 1, description will be given on a network selecting method in the first embodiment of the invention. A mobile node (MN) 100 is at the present moment within the range of overlapped networks. For instance, communicatable range of an attachment point (PoA-1) 102 via a link 1001 and a communicatable range of an attachment point (PoA-2) 104 via a link 1011 are overlapped on each other. These are two WLAN access points to cover the same area. It is possible that the two PoAs belong to different wireless access systems or to different networks, for instance one of PoAs is a base station of 3GPP network (see the Non-Patent Document 2 as given above), and the other of PoAs is a base station of IEEE (Institute of Electrical and Electronic Engineers) 802.16. Also, MN corresponds of MT as described above.

In this case, MN 100 must select one of the connecting networks (connecting PoA) for its desired communication session. Although only two PoAs are shown in FIG. 1, scenarios are not limited to this, and there may be more PoAs. In the first embodiment of the present invention, supports at two or more PoAs are included.

For example, in case there are two different physical interfaces to be used at MN 100 with respect to different PoAs, the selection means a selection of different interfaces. In case two PoAs belong to the same access technology and MN 100 uses only one physical interface, the selection means a selection of different PoAs connected from the same interface. This would be obvious to those skilled in the art. This difference does not exert influence on general operating principle of the first embodiment of the present invention. In the description given below, these are not distinctly differentiated from each other. Instead, in a second case, e.g. selection of different network at a single physical interface, is covered by the present invention in form of a different logical interface with respect to the connection, which is to become a candidate.

Here, it is supposed that MN 100 is going to communicate with CN 108. As shown in FIG. 1, PoAs (i.e. PoA-1 (102) and PoA-2 (104)) have different uplinks to CN 108. The uplinks are a link 1003 at PoA-1 (102) and a link 1013 at PoA-2 (104), for instance. The two links 1003 and 1013 join at CRN 106, and there is a link 1005 between CRN 106 and CN 108. Here, only two links are shown, while scenarios are not limited to two. In actual network, a network node or the like may be present between PoA and CRN 106. And this means that more network elements (also called network nodes) are included. To facilitate the explanation of the first embodiment of the present invention, the network nodes are not distinctly shown here.

The connection from CRN 106 to CN 108 is common to two different connections (i.e. connection from CN 108 to PoA-1 (102) and connection from CN 108 to PoA-2 (104)). Therefore, the actual selection of network or interface is important only at different sections. For instance, it is from a different interface to CRN 106.

FIG. 2 is a schematical block diagram to show a possible arrangement of MN 100 to support the first embodiment of the present invention. MN 100 comprises several elements relating to the first embodiment of the present invention. Its component elements are: Application and Policy Control Logic (APCL) 201, Network and Interface Selector (NIS) 203, and multiple Logical Interface (LI) 205. APCL 201 has a purpose to maintain construction or to construct communication session with CN 108. This module controls traffic to be sent from MN 100. Network selection at NIS 203 is carried out at a request sent from APCL 201 via an interface 2001. For instance, this includes an address of CN 108, with which APCL 201 is going to communicate. Also, there are several specific requests in the selection. For example, these are: a request to set access technology at higher priority, and a request to set metrics and cost at higher priority.

NIS 203 is to support actual network or interface selection. It controls LI 205, which is used in communication session based on determination of selection. To perform selection, it is necessary that information or control command is exchanged between NIS 203 and LI 205. It is executed between interfaces, e.g. via interfaces 2003 and 2005.

As shown in FIG. 2, there are a plurality of LIs, i.e. LI 1 (205a, . . . , LIn (205b), etc in MN 100. In the following, it may be described as LI (205) to indicate all LIs. These LIs (205) do not correspond to physical communication channel at MN 100. Instead, in the environment of the first embodiment of the present invention, these correspond to potential communication paths, which can be utilized by MN 100 at a certain communication session at a certain position. For instance, even when MN 100 has only one physical WLAN interface, two LIs, i.e. LI1 (205aand LIn (205b), are turned to potential communication paths at the present position because PoA-1 (102) and PoA-2 (104) provide two potential connections for the communication with CN 108. The concept of LI (205) is introduced in the description to accomplish a single solution procedure. In case of a single physical interface having a plurality of LIs (205), the physical interface must be able to exchange information with different POAs at the same time. Normally, this is a control message, which does not need a dedicated communication connection.

At this moment, MN 100 does not establish a dedicated communication association to different PoAs. Therefore, signaling of layer 3 cannot be exchanged between MN 100 and PoA, e.g. PoA-1 (102). MN 100 must improve option of the layer 2 to exchange with PoA. In order to execute selection of network or interface based on E2E QoS, several information elements must be delivered to PoA. An example of information to be exchanged between MN 100 and PoA, e.g. PoA-1 (102), is given below.

$$Net \text{-} Sel \text{-} Req := [ address of target ( correspondent node CN ) ] [ Session ID or information to generate session ID ] [ Number of PoAs to become candidates ( for connection ) ] [ Extra policy element ]$$

Here, the address of target is to specify the other end of concern to E2E QoS. For instance, it is the address of CN 108 to be indicated by APCL 201. The session ID is the information delivered by MN 100 to all PoAs in order to associate network selection procedure to be executed at different PoAs. PoAs have no direct relation with each other. Thus, the E2E QoS Query messages issued by the PoAs may use external information to bind. Therefore, the “Session ID or information to generate session ID” from the MN 100 helps the different PoAs to create an identifier, e.g. the SessionID (in case of NSIS framework (Next Step In Signaling, see the Non-Patent Document 2 as given above)), which allows the CRN 106 to correlates the messages from different PoAs when it is included.

The number of PoAs to become candidates is the number of the entire connection to become candidates to PoA. This is generally equal to the number of PoAs, to which MN 100 decides to transmit the message of Net-Sel-Req. The extra policy element is an optional element in the message to carry specified information to consider the network selection. For example, it is the priority of metrics. By this, APCL 201 can put emphasis on the delay rather than the band width. PoA makes this decision on the evaluation of E2E QoS. The message of Net-Sel-Req may include the information to indicate data flowing direction.

This message Net-Sel-Req is transmitted to all PoAs by NIS 203 of MN 100 via LI (205). As described above, Net-Sel-Req message is exchanged by using the layer 2. For instance, this message is sent by the procedure of IEEE 802.21 type (see the Non-Patent Document 3 as given above) for the message exchange. In this case, PoA, e.g. PoA-1 (102) or PoA-2 (104), does not have to become a physical wireless media terminal point, e.g. an access point of WLAN, Logical function of PoA is built up within the network.

In order to execute the network selection based on E2E QoS, PoA, e.g. PoA-1 (102) or PoA-2 (104), acts as E2E QoS signaling proxy for MN 100. After receiving the Net-Sel-Req message, PoA must generate E2E-Query message to check the QoS supported on itself and on the path of CN 108. When this E2E-Query message is transmitted to a correspondent node (here, it is CN 108), this message is intercepted by all signaling aware nodes as to be described later on transmission path of the message (SAN as described above), and a part of the information included in the message is stored in SAN as the state.

FIG. 3 shows an example of an arrangement to be used by PoA, e.g. PoA-1 (102) or PoA-2 (104), to support the first embodiment of the present invention. PoA 300 comprises three main component elements, and these are: Layer 2 Terminal Function (L2TF) 301, Proxy Control (PC) 303, and E2E Signaling Control Function (ESCF) 305. L2TF 301 is to receive the Net-Sel-Req message from MN 100. In case it is supported by IEEE 802.21, it is turned to Media Independent Handover Function (MIHF) on the network side. After receiving the Net-Sel-Req message, L2TF 301 delivers the corresponding information to PC 303. PC 303 checks the message and generates necessary information for the E2E-Query message.

At PoA 300, PC 303 can inquire about QoS of the layer 2 supported on wireless link from L2TF 301. For example, PC 303 of PoA-1 (102) can determine how is QoS, which can support on the link 1001 if MN 100 decides to make connection to PoA-1 (102). By using this information, PC 303 generates the details of QoS (QoS spec) to be inserted in the E2E-Query message as initial QoS parameters. At the same time, PC 303 generates session ID to be used in the E2E-Query message based on the information to generate the session ID. The different PoAs use a pre-determined algorithm so that different PoAs can generate the same session ID value or a related value can be generated. In case the session ID is generated at MN 100 and the generated session ID is transmitted, the process to generate the session ID is not needed.

The remaining elements, i.e. address of the target, number of PoAs to become candidates, and extra policy element are sent to ESCF 305 to generate a signaling message. In case of NSIS framework, ESCF 305 is QoS NSLP (NSIS Signaling Layer Protocol) (see the Non-Patent Document 4 as given above). An example of the messages to be generated is given below.

$$E 2 E \text{-} Query := [ Session ID ] [ Flow ID ] [ Path \text{-} Sel \text{-} Indicator Path Selection Indicator ] [ Total \text{-} Candidate ] [ Q Spec ] [ Policy element ]$$

In this case, the session ID is either the one generated by PC 303 by using the information to generate the session ID or the session ID transmitted from MN 100. The flow ID is the one generated according to the address information of the address of the target and the address of PoA 300. In case of the NSIS framework, the two identifiers correspond to the session ID and the flow ID of NSIS message respectively.

Path-Sel-Indicator indicates that it is a message to select the optimal path for MN 100. Therefore, it is a network element to receive the message (i.e. the node, which can process the signaling. It is also referred as a signaling aware node. The signaling aware node is SAN as described above). For instance, CRN 106 installs temporary state in order to facilitate network selection by Path-Sel-Indicator. Total-Candidate indicates the number of PoAs 300 to transmit the E2E-Query messages. Candidate-Counter is to assist the evaluation by the signaling aware node when network selection is determined. It is useful in case there are a plurality of PoAs, which can be a plurality of CRNs. Only CRN 106 where all paths come together can determine path selection. The Candidate-Selector is always set to 1 by PoA 300.

QSpec is a QoS spec, which can be supported on the path where the messages pass. It is updated by each of the signaling aware nodes in the network, which has local status. The policy element is to elucidate policy rules to be used in the determination of the network selection. For instance, the priority at different QoS parameters is set.

As described above, a part of the information included in the E2E-Query message is stored as the state together with other information in the signaling aware nodes. An example of such state is given below.

$$Q N E \text{-} State := [ Session ID ] [ Best Q Spec ] [ Best flow ID ] [ Total \text{-} Candidate ] [ Candidate \text{-} Counter ] [ Policy element ] [ Extra flow list ] [ Timer ]$$

Here, the session ID is a primary key to be used for state storage. This is a session ID to be obtained from E2E-Query message. The best QSpec includes the information on the best QoS spec to be provided from different PoAs 300 to the present signaling aware node. This is calculated by using different QSpecs from the E2E-Query message received separately based on the rules included in the policy element. The best flow ID indicates a path relating to the best QSpec, and it is information on a path to provide the best QSpec. In a node to receive only one E2E-Query message, the best QSpec is always equal to the QSpec of the received message, and the best flow ID is equal to the flow ID of the message. The extra flow list is empty in such case.

Total-Candidate is obtained from the “E2E-Query” message. Candidate-Counter is calculated by totaling all Candidate Counters from the received E2E-Query messages with same session ID but different flow ID. In case the Candidate-Counter reaches the value of Total-Candidate after receiving the E2E-Query message, this means that the current signaling aware node is CRN 106 on all of the paths to become candidates. Therefore, the decision of network selection at MN 100 is executed by this node. CRN 106 compares the stored best QSpec for control with QSpec of the received message by using the rules of the policy element. In case it is judged that the best QSpec (the QSpec stored in CRN 106) provides the more optimal QoS to MN 100, CRN 106 sends Point-to-Point Response message (PTP-Response message) associated with the best flow ID directly to PoA 300 that sent first E2E-Query message. This message (PTP-Response message) indicates the corresponding connection selected by the network for MN 100 based on the selection criteria to PoA 300.

After the PTP-Response message is received by ESCF 305 of PoA 300, the information is sent to L2TF 301 via PC 303. L2TF 301 notifies the result of the selection to MN 100 by using selection response (Sel-Response) of the layer 2 signaling message. This message (Sel-Response) is needed only for the selection to provide the simplest information to indicate selection. Therefore, the load is very low and not many wireless resources are consumed. Sel-Response is a simple message, and MN 100 has no need to perform the complicated calculation. NIS 203 has only the need to select LI 205 to receive Sel-Response as the desired connection. Then, regular connection buildup process, e.g. the layer 2 association, is started.

In a case where QSpec included in a second message (e.g. E2E-Query message sent from PoA-2) is better than the best QSpec stored in CRN 106 (QSpec included in a first message sent from PoA 300, e.g. PoA-1), PTP-Response message where the flow ID of the message is associated is transmitted to PoA, which transmitted the message (i.e. PoA-2). And similar processing is performed at the PoA receiving PTP-Response message and MN 100. Then, another LI 205 is selected as the result.

As an option, after CRN 106 has sent the PTP-Response message, E2E-Remove message is sent along the path other than the selected path in order to remove the installed state. In case CN 108 does not receive the E2E-Remove message after the elapse of a certain time period, it may be so designed that CN 108 itself determines the optimal path for MN 100 and the message may be transmitted to PoA on the path. When CRN 106 decides to skip this step, QNE-State is automatically removed by the signaling aware node when a predetermined time has elapsed. In case CRN 106 has decided to skip this step, CRN 106 may send a message to notify that the path has been selected to CN 108. In this case, if CN 108 does not receive the message to notify that the path has been selected within a predetermined time period from CRN 106, it may be so designed that CN 108 itself determines the path optimal for MN 100 and such message may be transmitted to PoA on the path.

Here, referring to FIG. 4, description will be given on the arrangement of the signaling aware node (relay node) as described above. As shown in FIG. 4, the relay node 400 comprises receiving means 401, updating means 402, transfer means 403, judging means 404, message generating means 405, and storage means 406. The receiving means 401 receives the E2E-Query message transmitted from PoA 300. The updating means 402 updates QSpec included in E2E-Query message based on QoS level, which can be provided by the relay node 400 and stores it as QNE-State in the storage means 406. The transfer means 403 transfers the E2E-Query message updated by the updating means 402 toward CN 108.

The judging means 404 judges whether the relay node 400 is judged as a crossover node to converge all of the E2E-Query messages or not based on the information of the session ID of the received E2E-Query message when a different E2E-Query message has been received after the transfer of the updated E2E-Query message. The message generating means 405 determines the optimal communication path between MN 100 and CN 108 based on the best QSpec information stored in the storage means 406 and on the information of QSpec included in the E2E-Query message received at the moment when the relay node 400 is a crossover node by the judging means 404. Then, the PTP-Response message to notify this fact to PoA 300 on the communication path is generated.

Next, referring to FIG. 5, description will be given on an example of message sequence in the first embodiment of the present invention. As shown in FIG. 5, after the presence of two PoAs, e.g. PoA-1 (102) and PoA-2 (104), has been found, MN 100 transmits Net-Sel-Req 1 and Net-Sel-Req 2 to PoA-1 and PoA-2 respectively (Steps S5001 and S5003). After receiving these messages, each of PoAs generates E2E-Query messages, e.g. E2E-Query 1 and E2E-Query 2, and transmits it to CRN 106 (Steps S5005 and S5007). In this case, in each of E2E-Query 1 and E2E-Query 2, information is included that Total-Candidate is 2 and Candidate-Counter is 1. E2E-Query 1 and E2E-Query 2 have the same session ID but have different flow IDs. When E2E-Query 1 reaches the CRN 106 first, a temporary QNE-State is generated at the CRN 106. Then, the information included in E2E-Query 1 (e.g. QSpec) is updated, and it is transferred toward CN 108 as E2E-Query 3 (Step S5009).

Then, when E2E-Query 2 reaches the CRN 106, two Candidate-Counter values are added, and the value is turned to be equal to the value of Total Candidate, thus making a trigger to start the selection procedure to CRN 106. CRN 106 compares the best spec of the maintained QNE-State with the QSpec of E2E-Query 2 according to the rules of the policy element. In case it is judged that the maintained best QSpec is the optimal, CRN 106 transmits PTP-Response message to PoA-1 (102) (Step S5011). After receiving the PTP-Response message, PoA-1 (102) transmits Sel-Response to MN 100 by using the layer 2 transport (Step S5013). This Sel-Response acts as a trigger to start the buildup of the connection with PoA-1 (102) to MN 100 (Step S5019). As described above, CRN 106 sends the E2E-Remove message along the path other than the path selected to remove the information of the installed state (QNE-State) (Steps S5015 and S5017).

To give security protection for the network selection, CRN 106 can provide verification of the decision for the purpose of preventing error at the time of decision. For instance, in the Net-Sel-Req message in Steps S5001 and S5003, MN 100 can insert a flag of each of extra policy elements in the message. These flags are added to the policy elements in the E2E-Query messages in Steps S5005 and S5007. When the PTP-Response message is transmitted in Step S5011, CRN 106 uses two flags so that the generated verification code is included. This verification code can be returned to MN 100 in the Sel-Response in Step S5013. This is useful for MN 100 to certify that the decision for the path selection has been made by a real CRN.

### 2nd Embodiment

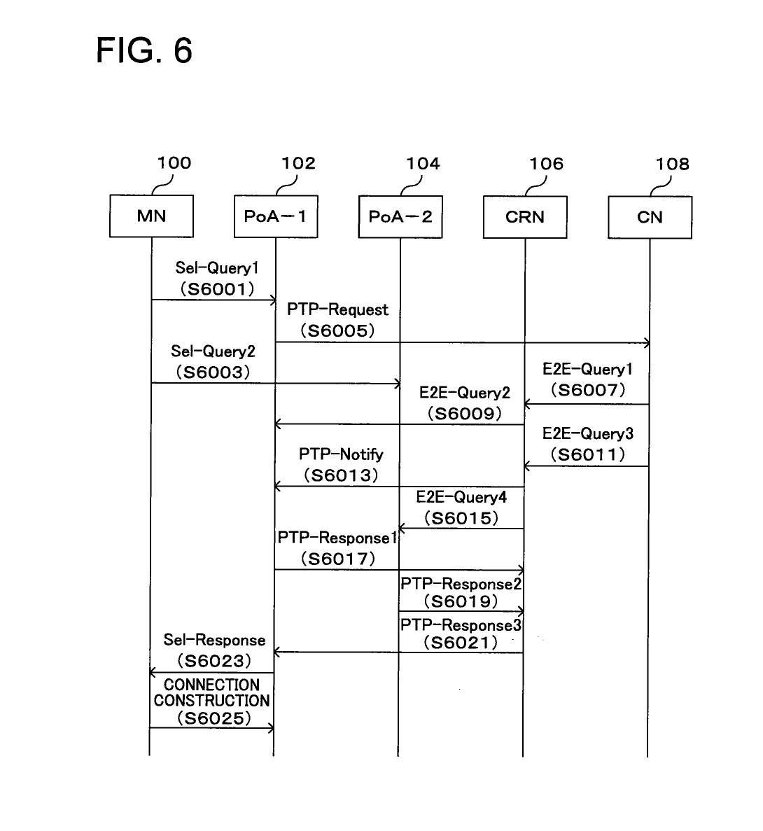

Next, referring to FIG. 6, description will be given on the processing sequence of a case where data traffic flows from CN 108 to MN 100. In this case, QoS Query message must be transmitted by CN 108 on behalf of MN 100. Therefore, there must be some changes in the procedure. However, this gives no influence on the principle of the invention, and these are apparent to those skilled in the art.

As shown in FIG. 6, MN 100 transmits Sel-Query 1 and Sel-Query 2 to different PoAs, e.g. PoA-1 (102) and PoA-2 (104) (Steps S6001 and S6003). In this case, however, one of PoAs, e.g. PoA-1 (102), is assigned in advance as a principal PoA (main PoA). After receiving the Sel-Query 1, PoA-1 (102), which is a main PoA, has all types of information of PoAs and transmits a PTP-Request message (Point-to-Point Request message) directly to CN 108 (Step S6005). This PTP-request message contains all types of information on different PoAs, e.g. number of PoAs to become candidates, policy elements, etc. and it serves as a trigger to urge CN 108 to transmit the E2E-Query message to the PoAs (to become candidates). The E2E-Query message to be transmitted by CN 108 (Steps S6007 and S6011) carries the same type of information as described in connection with the first embodiment.

When the E2E-Query 1 reaches CRN 106 first, CRN 106 generates a temporary Query state, e.g. Query-State, and the information of the E2E-Query 1 (e.g. QSpec) is updated. Because the State does not exist yet on CRN 106, it is transferred to PoA-1 (102) as E2E-Query 2 (Step S6009). When the E2E-Query 3 in Step S6011 reaches CRN 106 thereafter, CRN 106 compares Total-Candidate and Candidate-Counter and discovers that it is a crossover node (CRN) on different paths because the signaling aware nodes, which are to be the next receiving destination of E2E-Query 2, and that E2E-Query 4 are different. Then, CRN 106 transmits a PTP-Notify (Point-to-Point Notify) directly to the previous destination of the E2E-Query message, e.g. PoA-1 (102) (Step S6013). At the same time, CRN 106 updates the information of the Query message (E2E-Query 3) and transfers it to PoA-2 (104) as E2E-Query 4 (Step S6015). CRN 106 inserts the information to indicate that CRN has been already found in the E2E-Query 4 and inserts the address information of CRN 106 so that direct response will be directly transmitted from PoA-2 (104) to CRN 106. This is accomplished by setting other information elements in the Query message. For example, in case of NSIS, Response-Request element is set.

When PoA-1 (102) receives the PTP-Notify, PoA-1 (102) transmits a PTP-Response message (Point-to-Point Response message) directly to CRN, including QoS information on the paths collected by the E2E-Query 2 in Step S6009 (Step S6017). Similarly, when PoA-2 (104) receives the E2E-Query 4, PoA-2 (104) transmits the PTP-Response 2 directly to CRN 106 (Step S6019). After CRN 106 has received the responses from all of PoAs, CRN 106 compares them based on the rules of the policy element.

When the best path at MN 100 is determined, CRN 106 transmits the PTP-Response 3 to the selected PoA, e.g. PoA-1 (102) (Step S6021). PoA-1 (102) transmits the Sel-Response message to MN 100 by using the layer 2 transport (Step S6023). This is to urge MN 100 to start the buildup procedure together with PoA-1 (102) in the communication session. Then, MN 100 starts the connection procedure to PoA-1 (102) (Step S6025). Here, the arrangement of the relay node in the second embodiment is basically similar to the arrangement of the relay node in the first embodiment as described above. However, the direction to transfer the message by the transfer means is different because the flow of data traffic is different from that of the first embodiment.

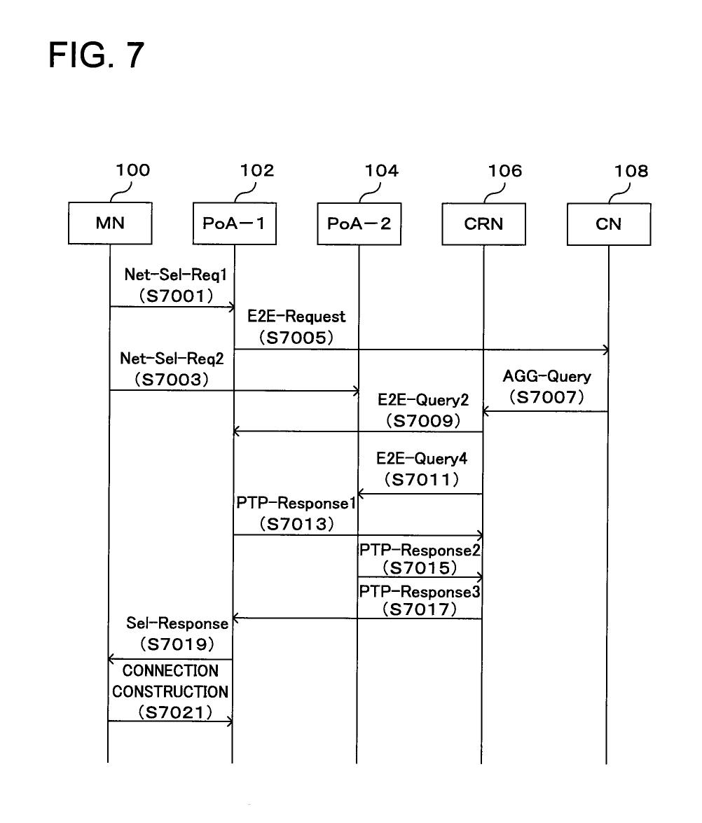

FIG. 7 shows a sequence of the optimal operation in case CN 108 starts Query message. The only difference from the case shown in FIG. 6 is that the E2E-Query message transmitted by CN 108 is replaced by AGG-Query message (Aggregated-Query). All of the flow IDs generated at different PoAs, e.g. PoA-1 (102) and PoA-2 (104), are included in the AGG-Query message. The flow ID checks the next hop node in all of the signaling aware nodes. Therefore, when CRN 106 finds that it is in itself a crossover node, CRN 106 inserts its own address information to the E2E-Query 2 in Step S7009 and to the E2E-Query 4 in Step S7011. Therefore, when different PoAs, e.g. PoA-1 (102) and PoA-2 (104), receive the E2E-Query message, these PoAs transmit the PTP-Response messages, e.g. the PTP-Response 1 and the PTP-Response 2 directly to CRN 106 respectively (Steps 57013 and S7015). Then, CRN 106 is urged to execute the network selection procedure at MN 100. The remaining operation (sequence) is similar to the one shown in FIG. 6, and detailed description is not given here.

### 3rd Embodiment

In the first and the second embodiments, the decision of the network selection for MN 100 is made by CRN 106. In the third embodiment, the decision of the network selection for MN 100 is not made by CRN 106, but it is made by CN 108. In this case, the signaling aware node along the path has no need to generate a temporary state in the E2E-Query message. Only CN 108 has the need to receive the results by all Query messages and to make decision of the network selection for MN 100. The PTP-Response message is transmitted directly from CN 108 to the selected PoA. Then, the results of the decision are notified to MN 100.

Here, discussion is made on a case where one of the E2E-Query messages is lost on the path or a case where the message cannot be transmitted along the corresponding path. When such phenomenon occurs, the current CRN 106 cannot be found. In order to avoid the stalemate or to promote earlier selection, CN 108 executes the network selection at MN 100 without waiting the discovery of CRN 106. For example, in case CRN is not found yet after CN 108 has received the first E2E-Query message within a certain time period, CN 108 transmits the PTP-Response message together with all available E2E-Query messages. Because the lost E2E-Query message passes along the slow path, which is not selected by MN 100 in most cases, this guarantees earlier discovery process.

Here, the relay node in the third embodiment is basically similar to the relay node in the first and the second embodiments, but the functions of the judging means and the message generating means are not specifically needed. When the updating means updates the information included in the received message (e.g. QSpec), there is no need to store it in the storage means, and the updated message is transferred by the transfer means. Also, in case of the relay node in the fourth embodiment as described below, it is the basically the same as the relay node in the third embodiment.

### 4th Embodiment

The main PoA selected in the second embodiment will be the main element for the decision of the network selection. In this case, address information of the main PoA will be notified to all PoAs by MN 100. When PoA receives the E2E-Query message from CN 108, PoA transfers the information of QSpec to the main PoA. Thus, the main PoA can make decision of the network selection for MN 100, and the adequate PoA to be connected will be notified.

### 5th Embodiment

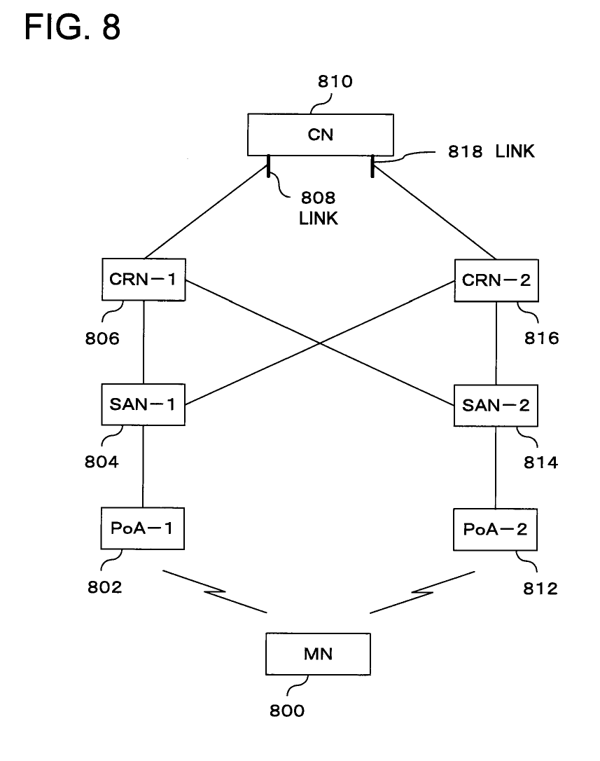

Now, referring to FIG. 8, description will be given on the fifth embodiment. In the fifth embodiment, description will be given on a case where CN 108 has a plurality of connection links, e.g. links 808 and 818. As shown in FIG. 8, there are different communication paths between MN 800 and CN 810. For instance, there are: a path from PoA-1 (802) to a link (connection link) 808, a path from PoA-1 (802) to a link (connection link) 818, a path from PoA-2 (812) to a link 808, and a path from PoA-2 (812) to a link 818.

The reason why a plurality of connection links are generated at CN 810 is apparent to those skilled in the art. For instance, a plurality of connection links are generated in case CN 810 is assigned to a plurality of addresses or in case CN 810 has a plurality of interfaces. But this exerts no influence on the principle of the present invention.

In case only one path between MN 800 and CN 810 can be used for communication, the comparison of the paths must be made between the four paths as given above.

In such case, when data traffic flows from MN 800 to CN 810, the process for the path selection is initiated by MN 800. This processing is similar to the method as explained in connection with the first embodiment. MN 800 transmits Net-Sel-Req message to PoAs, e.g. PoA-1 (802) and PoA-2 (812), by the method of local access technology. The Net-Sel-Req message contains the information on the address of CN 810. This information is in the form of actual IP address or host name. Unlike the case of the first embodiment, CN 810 has a plurality of links (link 808 and link 818) as shown in FIG. 8, and the types of information of these addresses are given in a list.

Also, the Net-Sel-Req message contains the information of the Signaling Aware Node (SAN) (primary proxy indicator information) acting as a proxy to determine adequate link combination (primary proxy). In case PoA of the receiving destination of the Net-Sel-Req message has a function as proxy, this indicator information may be a flag.

An example of the format of the Net-Sel-Req message is given below.

$$Net \text{-} Sel \text{-} Req := [ List of target addresses ] [ Session ID or information to generate session ID ] [ Number of PoAs to become candidates ( of connection ) ] [ Extra policy element ] [ Primary proxy indicator information ]$$

“Session ID or information to generate session ID”, “Number of PoAs to become candidates”, and “Extra policy element” are the same as those described in the first embodiment, and detailed description is not given here. Because the component elements of PoA in the fifth embodiment are the same as those of PoA as explained in the first embodiment, PoA in the fifth embodiment will be described by referring to FIG. 3.

When the Net-Sel-Req message has been received, PC 303 within PoA confirms the “list of target addresses”. When this list contains only one address, the processing explained in the first embodiment is carried out. In case the list contains a plurality of addresses of CN 810, PC 303 generates E2E-Query message to each of the addresses of CN 810. The plurality of addresses are provided directly by MN 800 via the Net-Sel-Req message. Or, in case the host name is provided by the Net-Sel-Req message, these addresses are obtained by the address resolving process, e.g. by Domain Name System (DNS) procedure.

These E2E-Query messages contain the information on the selection criteria as set up by MN 800. An example of the format is given below.

$$E 2 E \text{-} Query := [ Session ID ] [ Flow ID ] [ Destination \text{-} identifier ] [ Path \text{-} Sel \text{-} Indicator ( Path Selection Indicator ) ] [ Total Candidate ] [ Candidate \text{-} Counter ] [ Q Spec ] [ Policy element ]$$

“Destination-Identifier” provides destination information, i.e. information on the destination of the message, to which the message is sent. This is used to find out CRN for each destination. Specifically, in FIG. 8, CRN-1 (806) is CRN of E2E-Query messages to the address as assigned to the link 808. CRN-2 (816) is CRN of E2E-Query messages to the address as assigned to the link 818.

“Path-Sel-Indicator” indicates that this signaling message is for the path selection. This is the case of CN 810, which has a plurality of addresses. This is so designed that the signaling aware node on the path generates and stores the information necessary for the subsequent processing. In case of the path selection of CN 810 with a plurality of addresses, “Path-Sel-Indicator” also indicates whether the current path has been initiated from the primary proxy or not so that it will be made apparent by MN 800 via the Net-Sel-Req message. As an example, the following implementation can be considered: That is, 3 bits are assigned on the field. The first bit indicates whether the message is for “path selection” or not. The second bit indicates whether the message is on “CN with a plurality of addresses” or not, and the third bit shows whether the message has been sent from “primary proxy” or not. This field enables the proxy, e.g. PoA-1 802, to indicate if a fully scale path selection should be carried out. Even when CN 810 may have a plurality of addresses in a certain scenario, the proxy may select one of the plurality of addresses of CN 810 through information exchange with MN 800 by local method and the flag “CN with a plurality of addresses” may be turned off. In so doing, it is possible to execute more flexible signaling control.

“Total-Candidate”, “Candidate-Counter”, “Policy element”, etc. which are in the remaining fields of the E2E-Query message, are the same as those described in the first embodiment, and detailed description is not given here.

When the signaling aware node receives the E2E-Query message via the receiving means 401 shown in FIG. 4, the presence of “Path-Sel-Indicator” is checked, and it is understood that the message is for the path selection. In order that the “Path-Sel-Indicator” field indicates that the message is for the path selection with CN 810 with a plurality of addresses, the signaling aware node, e.g. SAN-1 (804) or SAN-2 (814), generates state information as given below. Generation and updating of the state information are carried out by the updating means 402 as described above.

$$Q N E \text{-} State := [ Session ID ] [ Destination \text{-} Identifier ] [ Best Q Spec ] [ Best flow ID ] [ Primary flow ID ] [ Total \text{-} Candidate ] [ Candidate \text{-} Counter ] [ Policy element ] [ Extra flow list := [ Flow ID ] [ Support Q Spec ] ] [ Timer ]$$

QNE-State comprises “Session ID”, “Destination-Identifier”, etc. A message containing the same “Session ID” and “Destination-Identifier” is used to update the state information. QNE-State contains “primary flow ID” field, and the flow ID of the signaling message with “path-Sel-Indicator” as set to the primary proxy is stored in it. “Extra flow list” contains the information from all of the received E2E-Query messages, and the E2E-Query messages have the “Path-Sel-Indicator” as set up for the same “Session ID”, “Destination-Identifier”, and “CN with a plurality of addresses.

The remaining field of QNE-State is the same as in the first embodiment, and detailed description is not given here.

When the signaling aware node receives the E2E-Query message with the “Path-Sel-Indicator”, which is set up for “path selection”, QNE-State is updated. In case “Candidate-Counter” is smaller than “Total-Candidate”, the signaling aware node (the transfer means 403 in FIG. 4) updates the field, e.g. “QSpec”, and transfers the E2E-Query message to the destination.

After the E2E-Query message has been received, if' the signaling aware node (the judging means 404 in FIG. 4), e.g. CRN-1 (806) recognizes that “Candidate-Counter” is equal to “Total-Candidate”, the signaling aware node, e.g. CRN-1 (806) regards that it is CRN in itself and stops the transfer of the E2E-Query message. Then, just as in the case of the first embodiment, “Best QSpec” and “Best flow ID” are calculated according to the information of “Extra flow list” and “Policy element”. This calculation may be made by the calculating means (not shown) newly installed in the component element as shown in FIG. 4, or may be made by other component element such as the judging means 404. After acquiring “Best QSpec”, CRN (the transfer means 403 in FIG. 4) transmits CRN-Query message to CN 810.

The method to generate and transfer the CRN-Query message is determined by “Policy element” stored by the signaling aware node. An example of the CRN-Query message is shown below. The CRN-Query message is generated by the message generating means 405 shown in FIG. 4.

$$C R N \text{-} Query := [ Session ID ] [ Plow ID ] [ Destination \text{-} Identifier ] [ Path \text{-} Sel \text{-} Indicator ] [ C R N indicator ] [ Q Spec ] [ Policy element ]$$

“CRN Indicator” is to differentiate CRN-Query message from E2E-Query message. The other part of the message is the same as the E2E-Query message except that there is no field for “Total-Candidate” and “Candidate-Counter”.

Upon receipt of the E2E-Query message, CN 810 abandons the message. However, when CN 810 receives the CRN-Query message on a certain interface or address, it responds with CRN-Response message. This CRN-Response message contains the information on QoS supported on the path, e.g. “QSpec” and “Flow ID”, and it is transmitted to CRN-1 (806), for instance. An example of the CRN-Response message is given below.

$$C R N \text{-} Response := [ Session ID ] [ Flow ID ] [ Destination \text{-} Identifier ] [ C R N Indicator ] [ Q Spec ] [ Policy element ]$$

“Session ID”, “Flow ID”, and “CRN Indicator” are obtained from the received CRN-Query message. “QSpec” is the final QoS guarantee recognized by CN 810 on the path. “Policy element” contains the favorite information of CN 810 at the path selection, e.g. the information of the priority in QoS metrics.

After receiving the CRN-Response message, the normal signaling aware node does not process it but transfer the message to CRN by the transfer means 402 of FIG. 4.

When CRN having QNE-State, which has “Total-Candidate” equal to “Candidate-Counter”, receives the CRN-Response message, the best E2E QSpec is calculated according to the information stored in QNE-State and “QSpec” of the message (e.g. calculation is made by the calculating means as described above). This best E2E QSpec indicates that it pertains to the best path between all of the PoAs and the address of CN 810 specified by “Destination-Identifier”.

After the best path to the address of CN 810 has been determined, CRN generates “PTP-Response” message to be transmitted to the primary proxy as indicated by MN 800 via the message generating means 405 of FIG. 4. CRN obtains the information relating to the primary proxy via “Primary flow ID” stored in QNE-State.

“PTP-Response” message contains the information of the supported best QSpec, a pair of addresses where the best QoS is supported, e.g. the information on the address of PoA and on a specific address of CN810. An example of the “PTP-Response” message is given below.

$$P T P \text{-} Response := [ Session ID ] [ Flow ID ] [ Best Q Spec ] [ Destination \text{-} Identifier ] [ Candidate PoA Address ]$$

“Candidate PoA Address” is obtained from “Best Flow ID” and “Destination-Identifier”. As an option, if the E2E-Query message contains “Candidate PoA Address” and it is stored by CRN, CRN can directly contain “Candidate PoA Address” in “PTP-Response” message.

At the primary proxy, e.g. at PoA-1 (802), when different “PTP-Response” messages are received from different CRNs, e.g. CRN-1 (806) and CRN-2 (816), the processing for comparison is carried out. The best path is selected according to “Best QSpec” of different “PTP-Response” message.

After the best path has been selected, the result is transmitted to MN 800 via “Sel-Response” message as in the first embodiment. However, the “Sel-Response” message should contain the information about the address of the CN 810 selected in the processing.

### 6th Embodiment

Now, description will be given on the sixth embodiment. In the description of the sixth embodiment, FIG. 8 is also used. In the sixth embodiment, the direction of the data traffic is from CN 810 to MN 800, and End-to-End Query message must be transmitted from CN 810 to MN 800. In the sixth embodiment, MN 800 transmits only one “Net-Sel-Req” message to PoA, e.g. PoA-1 (802), and the “Net-Sel-Req” message contains the information to indicate the direction, list of target addresses, and all PoAs (potentially connectable). An example of this message is given below.

$$Net \text{-} Sel \text{-} Req := [ Target address ] [ Session ID or information to generate session ID ] [ Number of Queries to become candidates ] [ List of addresses to become candidates ] [ Extra policy element ] [ Data Direction Indicator ]$$

“List of addresses to become candidates” is a list of addresses of PoAs. “Data Direction Indicator” is a field, which indicates that data flow is “from CN 810 to MN 800”. The other component elements of the message are the same as those explained in the fifth embodiment, and detailed description is not given here.

When PoA receives the “Net-Sel-Req” message with “Data Direction Indicator” “from CN 810 to MN 800”, E2E-Query-Request message is transmitted to CN 810. An example of the E2E-Query Request message is given below.

$$E 2 E \text{-} Query \text{-} Request := [ List of target addresses ] [ \begin{matrix}Session ID or information \\ to generate session ID\end{matrix} ] [ \begin{matrix}Number of Queries \\ to become candidates\end{matrix} ] [ \begin{matrix}List of addresses to \\ become candidates\end{matrix} ] [ Extra policy element ]$$

“List of target addresses” is a list of addresses, which belong to CN 810. CN 810 can support more addresses than those listed up in “the list of target addresses”. For example, it is a case where only several interfaces are allowed to use in the communication with MN 800 in response to the control policy. The remaining component elements of the message are the information obtained from the “Net-Sel-Req” message.

When CN 810 receives the “E2E-Query-Request” message, CN 810 transmits the E2E-Query message to the addresses listed in the “list of addresses to become candidates”. The corresponding information in the E2E-Query message is the information as explained in the fifth embodiment, and it contains “Path-Sel-Indicator” to indicate that the data direction is “from CN 810 to MN 800”, Total-Candidate” to indicate the number of all addresses of CN 810 to be used in the communication with MN 800, and “Destination-Identifier” to indicate one identifier among the addresses given in the “list of addresses to become candidates” in the E2E-Query-Request” message. In general, CN 810 acts as PoA at the interface or at the address used in the communication with MN 800. Extra information element to indicate address of the primary proxy must be included in the “E2E-Query” message. For instance, it must be included as the field of a new “primary proxy”.

The signaling aware node acts in similar manner to the signaling message as in the fifth embodiment. The only difference is the direction of message, and it is indicated by “Path-Sel-Indicator”. For instance, as shown in FIG. 8, SAN-1 (804) and SAN-2 (814) play the roles of CRN-1 (806) and CRN-2 (816) as described in the fifth embodiment. For instance, SAN-1 (804) and SAN-2 (814) are regarded as CRNs.

When CRN, e.g. SAN-1 (804), receives the “CRN-Response” message from MN 800 via the receiving means shown in FIG. 4 and obtains the “Best QSpec”, it transmits “PTP-Response” message to a primary proxy, e.g. PoA-1 (802), via the transfer means 403 of FIG. 4. The address of the primary proxy is obtained from the field of the “primary proxy” of the “E2E-Query” message. The primary proxy, e.g. PoA-1 (802), executes path selection necessary for MN 800 and notifies the result via an adequate “Sel-Response” message.

Unlike the case of the fifth embodiment, some of the “PTP-Response” messages may go off from the path (off-path). For instance, the message may flow from SAN-2 (814) to PoA-1 (802). Regarding the off-path message, signaling can directly specify the address to the destination, e.g. to PoA-1 (802), or can deliver it to PoA-1 (802) via the existing signaling paths, e.g. CRN-1 (806) and SAN-1 (804). In the case described below, CRN-1 (806) must recognize the “PTP-Response” message and transfer it to the primary proxy. This can be achieved by setting the behavior of CRN-1 (806) as described above.

### 7th Embodiment

Now, the seventh embodiment will be described. Here, also, FIG. 8 is referred for explaining the seventh embodiment. In case it is allowed to use a plurality of connections in the same session, the comparison of the paths must be executed between different path combinations. As the cases where a plurality of connections are used at the same time in FIG. 8, there are: a case where MN 800 uses two physical interfaces at the same time and CN 810 uses only one physical interface, and a case where MN 800 uses only one physical interface but CN 810 uses two physical interfaces at the same time. There are 4 types of cases: a case from PoA-1 (802) to the link 808 and from PoA-2 (812) to the link 818, a case from PoA-1 (802) to the link 808 and from PoA-2 (812) to the link 808, a case from PoA-1 (802) to the link 818 and from PoA-2 (812) to the link 808, and a case from PoA-1 (802) to the link 818 and from PoA-2 (812) to the link 818. As a case where a plurality of connections are used at the same time in FIG. 8, there is a case where both MN 800 and CN 810 use two physical interfaces. In such case, all paths are used, and there is no need to compare the paths.

To execute the comparison, the process similar to the one described in the fifth embodiment is carried out. In this case, some amendment of the processing may be necessary, but it exerts no influence on the principle of the present invention.

In case MN can make connection with a plurality of PoAs via the interfaces on both sides, it is so designed by MN that “Simultaneous-Access-Indicator” is included in “Extra Policy Element” in the “Net-Sel-Req” message to be transmitted to PoA. “Simultaneous-Access-Indicator” comprises 2 bits, for instance. The first bit indicates the MN side, and the second bit indicates the CN side. If the bit is off, it means that only one interface is used. If the bit is on, it means that the interfaces are used at the same time. In another example of the arrangement of “Simultaneous-Access-Indicator”, there are two fields, indicating the number of interfaces used by the MN side simultaneously and the number of interfaces used by the CN side simultaneously. In this case, MN 800 and CN 810 have 3 or more interfaces respectively, and this can be used when some of these are selected.

When PoA receives the Net-Sel-Req message, PoA processes the message as explained in the fifth embodiment. When PoA confirms “Simultaneous-Access-Indicator” of “Extra Policy Element”, it is so designed by PoA that a “Multi-Access” flag is included in “Path-Sel-Indicator” of “E2E-Query” message to be transmitted to CN 810. One example of such flag is a bit, which is defined in advance in the field of “Path-Sel-Indicator”. There are a bit to indicate the MN side and a bit to indicate the CN side. When the bit on the MN side is set to “true (on)”, it means that MN 800 and CN 810 use the connections by the interfaces on both sides or use all connections (potential connections) in the same communication session. On the other hand, when the bit is set to “false (off)”, it means that MN 800 or CN 810 uses only one of the connections in the communication session. Also, “Multi-Access” may be a field, and not a flag. For instance, the number of interfaces may be indicated which are used by MN 800 or CN 810.

In another aspect, MN can have a plurality of interfaces, but only a certain fixed number of them can be used in the same communication. This is because the problems of batteries or costs are taken into account. In such cases, MN 800 can include such information in the “Simultaneous-Access-Indicator” with the extended element of “E2E-Query” message. A “Multi-Access” flag of “true” “Path-Sel-Indicator” is set to PoA by such extended element.

The signaling aware node, e.g. CRN-1 (806), processes the message and proceeds with the processing as described in the fifth embodiment. For instance, CRN-Query message is transmitted to CN 810. In QNE-State, “Path-Sel-Indicator” is included in “Policy element”. In case it is indicated in “Multi-Access” flag (or field) that both MN 800 and CN 810 use all interfaces, all paths are used simultaneously, and there is no need to compare the paths. In this case, signaling aware node may neglect the “Path-Sel-Indicator” and may perform the processing by regarding it as an ordinary Query message.

When CRN receives the “CRN-Response” message via the receiving means 401 of FIG. 4, QNE-State is checked.

If the “Multi-Access” flag of “Path-Sel-Indicator” is “true”, CRN generates an extended “PTP-Response” message to transmit to the selected PoA via the message generating means 405 of FIG. 4. An example of this message is given below.

$$P T P \text{-} Response := [ Session ID ] [ Flow ID ] [ Best Q Spec ] [ Destination \text{-} Identifier ] [ Candidate PoA Address ] [ Path \text{-} Info := [ Flow ID ] [ Q Spec ] ]$$

The element of “Path-Info” includes all types of path information, which can be identified at CRN. This is the information of path identifier. For example, it includes the information on the flow ID and on the QoS, for instance QSpec to be supported.

When the selected PoA receives all of the “PTP-Response” message, PoA calculates QoS support in different path combinations. PoA compares all QoS supports in different path combinations. By “Simultaneous-Access-Indicator” as transmitted by MN 800, the selected PoA selects the best path combination based on QoS support and another policy set by MN 800. The selection of combination is transmitted to MN 800 via the extended “Sel-Response” message. A list of the selected PoAs and the information of interfaces to correspond to CN 810 are included in it. Based on such information, MN 800 can easily identify the interface to be used and can identify the address or the interface of CN 810 to be connected.

### 8th Embodiment

Description will be given below on the eighth embodiment of the invention. Here also, FIG. 8 is used to explain the eighth embodiment. In the eighth embodiment, direction of the data traffic is from CN 810 to MN 800. The extension of the same message as described in the seventh embodiment and the same procedure of QNE-State described in the sixth embodiment are applied. This would be easily recognized by those skilled in the art, and no influence is exerted on the principle of the present invention.

### 9th Embodiment

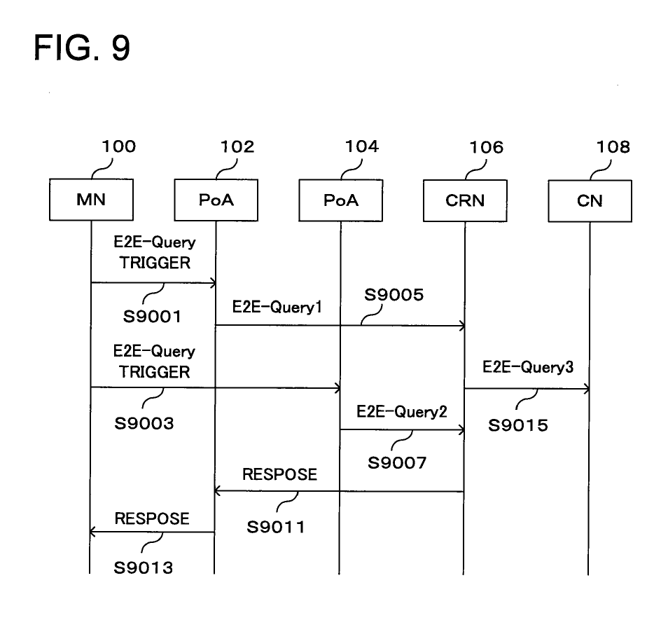

In the embodiments as described above, MN 100 shown in FIG. 1, for instance, has one or more interfaces. If it has no CoA, the proxy (PoA) transmits E2E-Query message for MN 100, and the network side selects the path, which is optimal to MN 100. In order to initiate the procedure to select the interfaces, as shown in FIG. 9, MN 100 transmits a trigger for “E2E-Query message” (E2E-Query trigger) to all potential proxies (e.g. PoA 102 and PoA 104) via the layer 2 link (Steps S9001 and S9003).

Each proxy transmits E2E-Query messages (e.g. E2E-Query 1 and E2E-Query 2) as shown in FIG. 9) to CN 108 (Steps S9005 and S9007). After receiving the E2E-Query 1, CRN 106 transmits E2E-Query 3 to CN 108 (Step S9015). When the E2E-Query messages are converged to CRN 106, CRN 106 sends back the response to MN 100 (Step S9011) and notifies the selected path to MN 100 (Step S9013). By this procedure, the network node (e.g. CRN, CN and proxy) selects the optimal path at MN 100, and the information of “optimal path” is transmitted to MN 100 via the L2 (layer 2) link. However, in the first to the eighth embodiments as given above, no consideration is given on resource reservation after the selection of the optimal path.

According to the technique described in US 2006/0083238, “Resource Reservation Method Using Multiple Interfaces in Mobile Environments; Sung-Hyuck Lee et al.; Apr. 20, 2006, MN transmits E2E-Query message via all potential interfaces to CN. When all of these Query messages reach CN, CN selects the optimal path and transmits RESERVE message to MN. However, according to the present invention, all messages reach CN. This induces overhead of the network. Then, the problem is solved by taking the arrangement as described later.

In the description given below, numerical figures, time, number of connections of nodes, parameters, etc. are set in such manner as to facilitate the explanation. However, it would be obvious to those skilled in the art that the embodiment of the invention can be carried out without the details as given above.

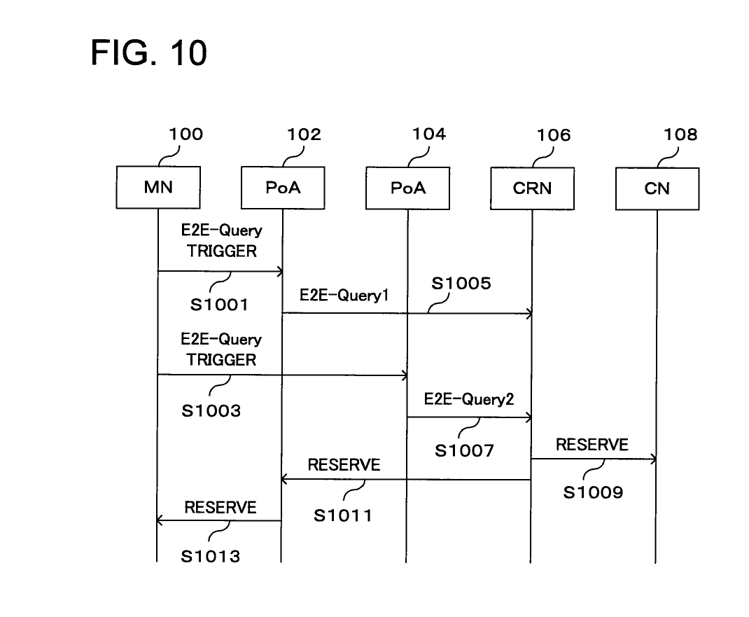

For example, in case MN 100 shown in FIG. 1 has a pre-assigned CoA, MN 100 transmits E2E-Query trigger messages to connection destinations PoAs 102 and 104 to send E2E-Query messages as shown in FIG. 10 (Steps S1001 and 1003). Each trigger contains CoA of MN 100. PoA 102 and PoA 104 transmit E2E-Query message 1 and E2E-Query message 2 to CN 108 respectively (Steps 51005 and S1007). Because the two E2E-Query messages pass, these messages are converged at CRN 106. CRN 106 selects the optimal path and transmits RESERVE message to the selected path and to CN 108 (Steps S1009 and S1011).

When MN 100 does not have its own CoA, PoAs (e.g. PoA 102 and PoA 104) can provide CoA of MN 100, which is stored in itself. This is possible if PoA has DHCP function or it has a stored CoA of MN 100 in case of a handover of Ping-Pong type. In this case, when PoAs (e.g. PoA 102 and PoA 104) receive trigger for E2E-Query message from MN 100, each of the PoAs acquires one CoA of MN 100 from the stored CoAs and sets it into E2E-Query message. Because the E2E-Query messages are transmitted to CN 108, these messages are converged at CRN 106. CRN 106 selects the optimal path and transmits the RESERVE messages to the selected PoA or to PoAs (PoA 102 and PoA 104) and to CN 108 respectively (Steps S1011 and S1009). When the RESERVE message has been received, PoA 102, for instance, transfers the RESERVE message to MN 100 (Step S1013). In order to use a plurality of paths at the same time (e.g. for load balance purpose), CRN 106 may send the RESERVE messages to one or more PoAs (e.g. PoA 102 and PoA 104). This method is useful when enough optimal path is not found in all of the paths.

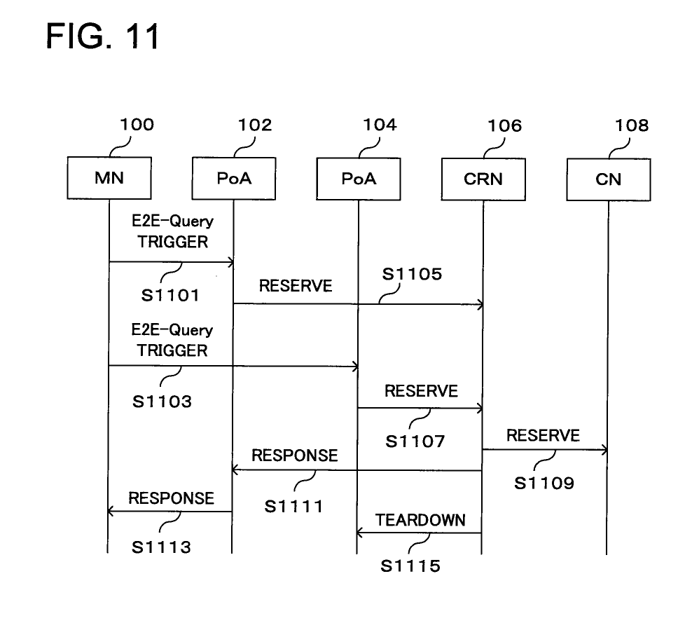

As shown in FIG. 11, when the data flow direction is from MN 100 to CN 108, PoAs (e.g. PoA 102 and PoA 104), upon receiving triggers of E2E-Query messages (Steps 51101 and S1103) transmit the RESERVE messages directly to CN 108 (Steps S1105 and S1107). When the RESERVE messages are converged to CRN 106, CRN 106 selects the optimal path and transmits the RESPONSE message to the selected path (Steps S1111 and S1113) and transfers the RESERVE message to CN 108 (Step S1109). As shown in FIG. 11, CRN 106 transmits a TEARDOWN message for the purpose of deleting the reservation status of QNE on the path, which has not been selected (Step S1115).

### 10th Embodiment

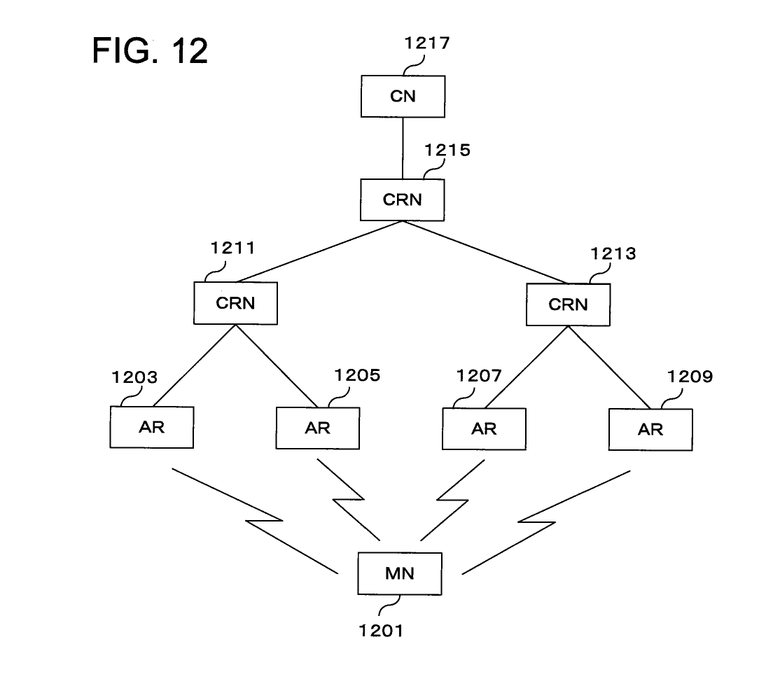

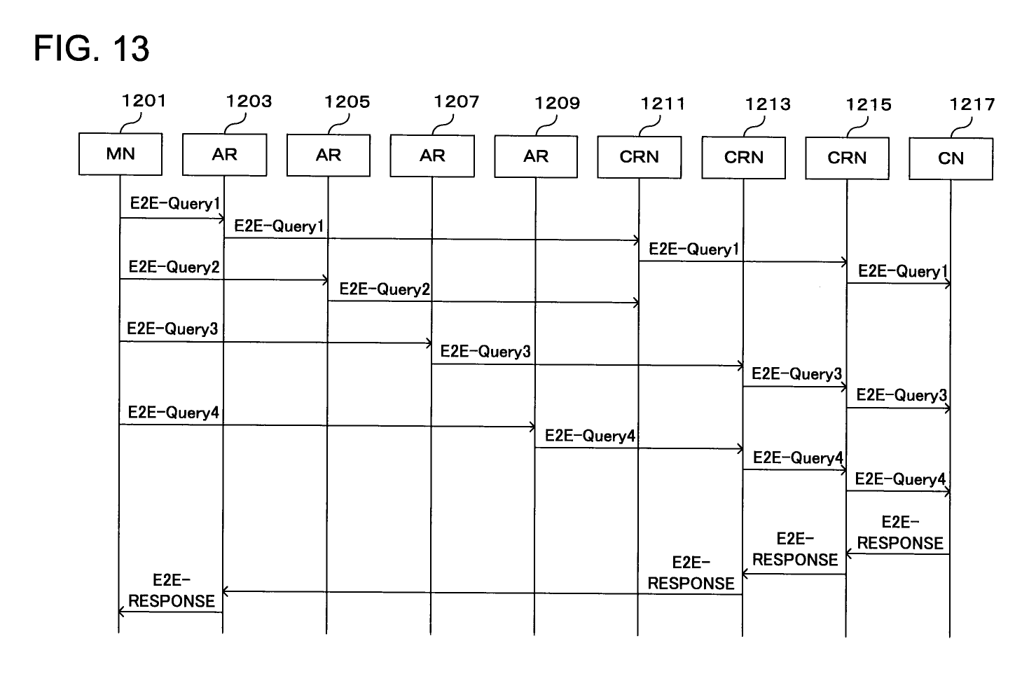

As shown in FIG. 12, in case there are one or more CRNs in the same session, as shown in FIG. 13, when E2E Query messages (e.g. E2E-Query 1, E2E-Query 2, E2E-Query 3, and E2E-Query 4) sent by MN1201 pass through CRN 1211, CRN 1213 and CRN 1215, for instance, three CRNs allow the first passing Query message (e.g. E2E-Query 1) to pass. However, CRN compares any further QUERY messages received afterwards (e.g. E2E-Query 2) with the previously received Query message (e.g. E2E-Query 1). If the Query message received subsequently has more usable resources than the previously received Query message, CRN allows the E2E-Query message (e.g. E2E-Query 4 shown in FIG. 13) to pass. Otherwise, the E2E-Query message (e.g. E2E-Query 2 shown in FIG. 13) is abandoned. This processing is advantageous in that the overhead is decreased in E2E-Query message processing on a plurality of paths.

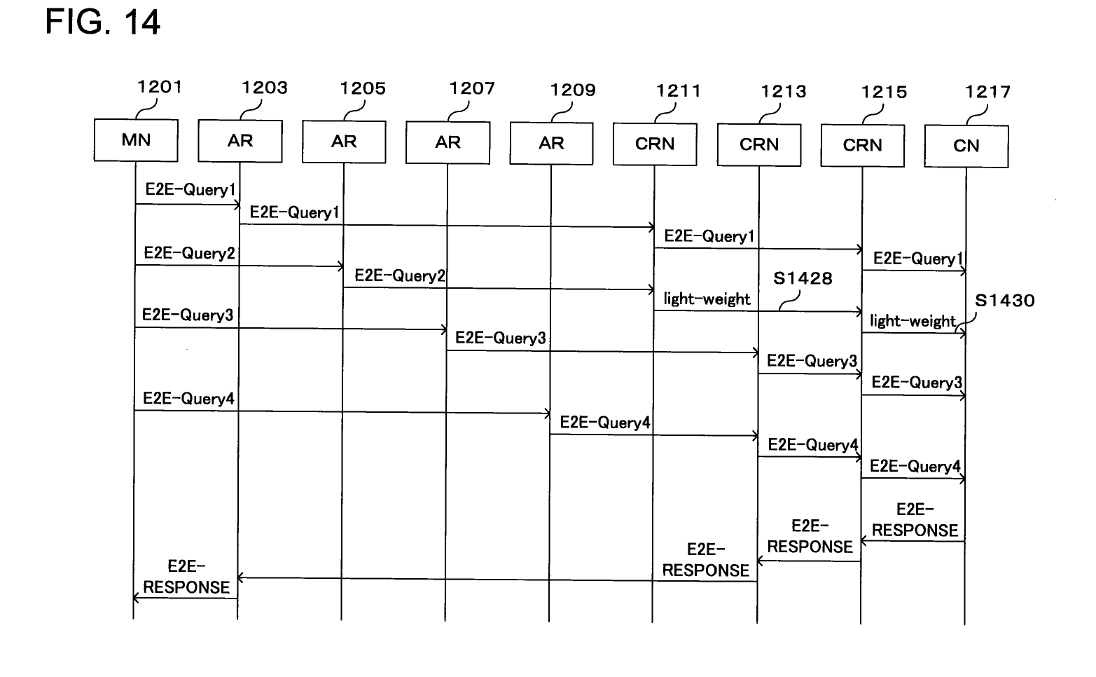

Also, CN 1217 shown in FIG. 12 can set the time “T” to wait for a time “T” before selection of path on a timer in order to receive the other Query messages. Alternately, the intermediate CRN such as CRN (1211) or CRN (1213) as shown in FIG. 12 transmits a light-weight message with lower load to CRN 1217 to notify the E2E-Query message abandoned by CRN shown in FIG. 14 (Steps S1428 and S1430).

In the above, examples have been taken on the case of the arrangement shown in FIG. 1, while the invention can also be carried out in other cases, e.g. the case with the arrangement as shown in FIG. 8.

Each of the functional blocks used in the description of the embodiments above can be achieved as LSI, which is typically an integrated circuit. These may be provided in one chip or may be produced in one chip including a part or all. Here, it is referred as LSI, while it may be called IC, system LSI, super-LSI, or ultra LSI depending on the difference in the degree of integration. The method to provide integrated circuit is not limited to LSI, and it may be produced as a special-purpose circuit or as a general-purpose processor. After manufacturing the LSI, FPGA (Field Programmable Gate Array) or reconfigurable processor may be used, in which connection and setting of circuit cells inside LSI can be reconfigured. Further, if a new technique of circuit integration emerges to replace LSI with the progress of semiconductor technique or other technique derived from it, the functional blocks may be integrated by using such technique. For example, the adaptation of biotechnology may belong to such case.

### INDUSTRIAL APPLICABILITY

In the method for selecting attachment points and the relay node used in the method according to the present invention, the communication with higher efficiency can be achieved by selecting the connecting access points to be connected according to the quality of end-to-end communication between a mobile node and a correspondent node when there are a plurality of access points. Therefore, this technique is used for the method for selecting attachment points and for the relay node used in the method when there are a plurality of attachment points in wireless communication between a correspondent node and a mobile node.

1. A method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises:
a step where said mobile node transmits a first message to request the selection of said access point to be connected by said mobile node to each of said access points to become candidates of the connection;
a step where said access point transmits, upon receipt of said first message, a second message including a specified information necessary for the selection of said access point to be connected by said mobile node to said communication apparatus; and
said relay node, upon receipt of said second message, updates said specified information contained in said second message based on QoS level providable by said relay node and stores said updated information in a specified storage area, transfers the updated second message to said communication apparatus, and in case a second message, transmitted by an access point different from said access point transmitting said second message received previously, has been received, it is judged whether or not the relay node itself is a crossover node to converge all of said second messages based on said specified information of said received second message, and in case it is judged that it is said crossover node, said relay node determines an optimal path between said mobile node and said communication apparatus based on said specified information stored in said specified storage area and on said specified information of said second message received currently, and transmits a third message to notify that it is the optimal communication path to said access points on said optimal communication path.

2. The method for selecting attachment points according to claim 1, wherein said first message contains at least address information of said communication apparatus, information of session ID generated by said mobile node or information to generate session ID at an access point of transmission destination of said first message, and information on number of said access points to become candidates of said connection.

3. The method for selecting attachment points according to claim 2, wherein said specified information contained in said second message comprises at least information of said session ID, information of flow ID generated according to address information of said access point to transmit said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path.

4. The method for selecting attachment points according to claim 3, wherein said relay node stores in said specified storage area, after the information to indicate said QoS information of said specified information contained in said second message has been updated, at least information of said session ID contained in said second message, information to indicate QoS information providable from said access point to said relay node, information to provide a path to correspond to the information to indicate said QoS information, information on number of access points transmitting said second message contained in said second message, and information on number of said second messages with the same session ID but different flow ID.

5. The method for selecting attachment points according to claim 4, wherein said relay node judges whether the relay node itself is said crossover node or not based on information of said session ID stored in said specified storage area and on information of session ID included in said second message received currently.

6. A method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises:
a step where said mobile node transmits a first message to request the selection of said access point to be connected to each of said access points to become candidates of the connection;
a step a specified access point among said access points to become candidates of said connection transmits, upon receipt of said first message, a second message to request the transmission of a third message including a specified information necessary for selection of said access point to be connected by said mobile node;
a step where said communication apparatus, upon receipt of said second message, transmits said third message to each of said access points to become candidates of said connection of said mobile node; and
said relay node, upon receipt of said third message, updates said specified information included in said third message based on QoS level providable by itself and stores said updated information to a specified storage area, transfers said updated third message to said access point to become candidate of said connection, and in case a third message transmitted to a transmission destination different from the transmission destination of said third message previously received is received subsequently, said relay node judges whether or not said relay node itself is a crossover node having passed all of said third messages and having branching of the path according to said specified information of said received third message, and in case said relay node judges, said relay node receives said types of information of said third message from said access points to be candidates of said connection of said mobile node of transmission destination of said third message, determines an optimal path between said mobile node and said communication apparatus based on these types of information, and transmits a fourth message to notify that it is the optimal communication path to said access point on said optimal communication path.

7. The method for selecting attachment points according to claim 6, wherein said first message contains at least address information of said communication apparatus, information of session ID generated by said mobile node, or information to generate session ID at access point of transmission destination of said first message, and information on number of said access points to become candidates of said connection.

8. The method for selecting attachment points according to claim 7, wherein said second message contains at least information of flow ID generated according to the address information of said access point to become candidates of said connection, and information on number of said access points to become candidates of said connection.

9. The method for selecting attachment points according to claim 8, wherein said specified information contained in said third message comprises at least information of said session ID, information of said flow ID generated according to address information of said access point of transmission destination of said third message, information to indicate a request to select an optimal communication path between said mobile node and said communication apparatus, information on number of said access points to transmit said third message, information used when said mobile node selects said access point to be connected, and information to indicate QoS information as updatable at said relay node on the path where said third message passes and providable on said path.

10. The method for selecting attachment points according to claim 9, wherein said relay node stores in said specified storage area, after the information to indicate said QoS information of said specified information contained in said third message has been updated, at least information of said session ID contained in said third message, information to indicate QoS information providable from said access point to said relay node, information to provide a path to correspond to the information to indicate said QoS information, information on number of access points transmitting said third message, contained in said third message, and information on number of said third messages with the same session ID but different flow ID.

11. The method for selecting attachment points according to claim 10, wherein said relay node judges whether or not the relay node itself is said crossover node based on information of said session ID stored in said specified storage area, and also based on information of session ID included in said third message received currently.

12. A method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises:
a step where said mobile node transmits a first message to request the selection of said access point to be connected to each of said access points to become candidates of the connection;
a step where said access point, upon receipt of said first message, transmits a second message including specified information necessary for selection of said access point to be connected by said mobile node to said communication apparatus;
a step where said relay node, upon receipt of said second message, updates said specified information contained in said second message based on QoS level providable by the relay node and transfers said updated second message to said communication apparatus;
a step where said communication apparatus, upon receipt of said second message updated by said relay node, determines the optimal communication path between said mobile node and said communication apparatus based on said specified information contained in all of said received second messages and notifies that it is the optimal communication path to said access points on said optimal communication path.

13. The method for selecting attachment points according to claim 12, wherein said first message contains at least address information of said communication apparatus, information of session ID generated by said mobile node or information to generate session ID at an access point of transmission destination of said first message, and information on number of said access points to become candidates of said connection.

14. The method for selecting attachment points according to claim 13, wherein said specified information contained in said second message comprises at least information of said session ID, information of flow ID generated according to address information of said access point to transmit said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path.

15. A method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises:
a step where said mobile node transmits a first message to request the selection of said access point to be connected to each of said access points to become candidates of the connection;
a step where a specified access point among said access points to become candidates of said connection transmits, upon receipt of said first message, a second message to request to transmit a third message containing a specified information necessary for selection of said access point to be connected by said mobile node;
a step where said communication apparatus, upon receipt of said second message, transmits said third message to each of said access points to become candidates of said connection of said mobile node;
a step where said relay node, upon receipt of said third message, updates said specified information contained in said third message based on QoS level providable by said relay node and transfers said updated third message to said access point to become candidate of said connection;
a step where each of said access points, upon receipt of said third message updated by said relay node, transmits a fourth message containing said specified information included in said received third message to said communication apparatus;
a step where said communication apparatus, upon receipt of said fourth message, determines an optimal communication path between said mobile node and said communication apparatus based on said specified information of said fourth message and transmits a fifth message to notify that it is the optimal communication path to said access point on said optimal communication path.

16. The method for selecting attachment points according to claim 15, wherein said first message contains at least address information of said communication apparatus, information of session ID generated by said mobile node, or information to generate session ID at an access point of transmission destination of said first message, and information on number of said access points to become candidates of said connection.

17. The method for selecting attachment points according to claim 16, wherein said second message contains at least information of flow ID generated according to address information of said access points to become candidates of said connection, and information on number of said access points to become candidates of said connection.

18. The method for selecting attachment points according to claim 17, wherein said specified information contained in said third message comprises at least information of said session ID, information of flow ID generated according to address information of said access point to transmit said third message, information to indicate a request to select an optimal communication path between said mobile node and said communication apparatus, information on number of said access points to transmit said third message, information used when said mobile node selects said access point to be connected, and information to indicate QoS information as updatable at said relay node on the path where said third message passes and providable on said path.

19. A method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said method comprises:
a step where said mobile node transmits a first message to request the selection of said access point to be connected by said mobile node to each of said access points to become candidates of the connection;
a step where a specified access point among said access points to become candidates of said connection transmits, upon receipt of said first message, a second message to request to transmit a third message containing a specified information necessary for selection of said access point to be connected by said mobile node;
a step where said communication apparatus, upon receipt of said second message, transmits said third message to each of said access points to become candidates of said connection of said mobile node;
a step where said relay node, upon receipt of said third message, updates said specified information contained in said third message based on QoS level providable by said relay node and transfers said updated third message to said access point to become candidate of said connection;
a step where each of said access points transmits, upon receipt of said third message updated by said relay node, a fourth message containing said specified information included in said received third message to said specified access point;
a step where said specified access point, upon receipt of said fourth message, determines an optimal communication path between said mobile node and said communication apparatus based on said specified information of said fourth message and transmits a fifth message to notify that it is the optimal communication path to said access point on said optimal communication path.

20. The method for selecting attachment points according to claim 19, wherein said first message contains at least address information of said communication apparatus, information of session ID generated by said mobile node, or information to generate session ID at an access point of transmission destination of said first message, and information on number of said access points to become candidates of said connection.

21. The method for selecting access points according to claim 20, wherein said second message contains at least information of flow ID generated according to the address information of said access point to become candidates of said connection, and information on number of said access points to become candidates of said connection.

22. The method for selecting attachment points according to claim 21, wherein said specified information contained in said third message comprises at least information of said session ID, information of flow ID generated according to address information of said access point to transmit said third message, information to indicate a request to select an optimal communication path between said mobile node and said communication apparatus, information on number of said access points to transmit said third message, information used when said mobile node selects said access point to be connected, and information to indicate QoS information as updatable at said relay node on the path where said third message passes and providable on said path.

23. A relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said relay node comprises;
receiving means for receiving a second message containing a specified information necessary for selection of said access point to be connected by said mobile node based on a first message to request selection of said access point to be connected by said mobile node;
updating means for updating said specified information contained in said second message received via said receiving means based on QoS level providable by said relay node itself and storing the information in a specified storage area;
transfer means for transferring said updated second message to said communication apparatus;
judging means for judging whether or not the relay node itself is a crossover node to converge all of said second messages based on the second message transmitted by a transmission source different from the transmission source of said second message previously received after the transfer of said updated second message; and
message generating means for determining an optimal communication path between said mobile node and said communication apparatus based on said specified information stored in said specified storage area and on said specified information of said second message received currently in case it is judged that the relay node itself is said crossover node by said judging means, and for generating a third message to notify that it is the optimal communication path to said access point on said optimal communication path.

24. A relay node according to claim 23, wherein said first message contains at least address information of said communication apparatus, information of session ID generated by said mobile node, or information to generate session ID at an access point of transmission destination of said first message, and information on number of said access points to become candidates of said connection.

25. A relay node according to claim 24, wherein said specified information contained in said second message comprises at least information of said session ID, information of flow ID generated according to address information of said access point to transmit said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path.

26. A relay node according to claim 25, wherein said updating means stores in said specified storage area, after the information to indicate said QoS information of said specified information contained in said second message has been updated, at least information of said session ID contained in said second message, information to indicate QoS information providable from said access point to said relay node, information to provide a path to correspond to the information to indicate said QoS information, information on number of access points transmitting said second message, contained in said second message, and information on number of said second messages with the same session ID but different flow ID.

27. A relay node according to claim 26, wherein said judging means judges whether the relay node itself is said crossover node or not based on information of said session ID stored in said specified storage area and on information of session ID included in said second message received currently.

28. A relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said relay node comprises:
receiving means for receiving a first message including a specified information necessary for selection of said access points to be connected by said mobile node;
updating means for updating said specified information contained in said first message received via said receiving means based on QoS level providable by said relay node itself and for storing the information in a specified storage area;
transfer means for transferring said updating first message to said access point to become candidate of said connection;
judging means for judging whether the relay node itself is crossover node or not, where all of said first messages pass through and which has branching on the path, in case a first message with a transmission destination different from the transmission destination of said first message previously received has been received after the transfer of said updated first message;
message generating means for determining the optimal communication path between said mobile node and said communication apparatus based on said specified information of said first message received respectively from said access points to become candidates of said mobile node with the transmission destination of said first message when it is judged that the relay node itself is a crossover node by said judging means, and for generating a second message to notify that it is the optimal communication path to said access point on said optimal communication path.

29. A relay node according to claim 28, wherein said specified information contained in said first message comprises at least information of said session ID and information of flow ID generated according to address information of said access point to transmit said first message, information to indicate a request to select an optimal communication path between said mobile node and said communication apparatus, information on number of said access points to transmit said first message, information used when said mobile node selects said access point to be connected, and information to indicate QoS information as updatable at said relay node on the path where said first message passes and providable on said path.

30. A relay node according to claim 29, wherein said updating means stores in said specified storage area, after the information to indicate said QoS information of said specified information contained in said first message has been updated, at least information of said session ID contained in said first message, information to indicate QoS information providable from said access point to said relay node, information to provide a path to correspond to the information to indicate said QoS information, information on number of access points contained in said first message and transmitting said first message, and information on number of said first messages with the same session ID but different flow ID.

31. A relay node according to claim 30, wherein said judging means judges whether the relay node itself is said crossover node or not based on information of said session ID stored in said specified storage area and on information of session ID included in said second message received currently.

32. A relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said relay node comprises:
receiving means for receiving a second message containing a specified information necessary for selection of said access point to be connected by said mobile node based on a first message to request selection of said access point to be connected by said mobile node;
updating means for updating said specified information contained in said second message received via said receiving means based on QoS level providable by said relay node itself; and
transfer means for transferring said updated second message to said communication apparatus.

33. A relay node according to claim 32, wherein said first message contains at least address information of said communication apparatus, information of session ID generated by said mobile node, or information to generate session ID at an access point of transmission destination of said first message, and information on number of said access points to become candidates of said connection.

34. A relay node according to claim 33, wherein said specified information contained in said second message comprises at least information of said session ID and information of flow ID generated according to address information of said access point to transmit said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path.

35. A relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication, and one or more relay nodes positioned between said plurality of access points and said communication apparatus and capable to receive and to process the messages with a specified quality transmitted and received between said mobile node and said communication apparatus, wherein said relay node comprises:
receiving means for receiving a first message containing a specified information necessary for selection of said access point to be connected by said mobile node;
updating means for updating said specified information contained in said first message received via said receiving means based on QoS level providable by the relay node itself; and
transfer means for transferring said updated first messages to said access point to become candidate of said connection.

36. A relay node according to claim 35, wherein said specified information contained in said first message comprises at least information of said session ID and information of flow ID generated according to address information of said access point to transmit said first message, information to indicate a request to select an optimal communication path between said mobile node and said communication apparatus, information on number of said access points to transmit said first message, information used when said mobile node selects said access point to be connected, and information to indicate QoS information as updatable at said relay node on the path where said first message passes and providable on said path.

37. A method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication and having a plurality of interfaces, and one or more relay nodes positioned between said plurality of access points and said communication apparatus and capable to receive and to process the messages with a specified quality transmitted and received between said mobile node and said communication apparatus, wherein said method comprises:
a step where said mobile node transmits a first message to request selection of said access point to be connected to each of said access points to become candidates of connection;
a step where said access point, upon receipt of said first message, transmits a second message containing a specified information necessary for selection of said access points to be connected by said mobile node to said communication apparatus;
a step wherein said relay node, upon receipt of said second message, updates said specified information contained in said second message based on QoS level providable by the relay node itself and stores said updated information in a specified storage area, transfers said updated second message to said communication apparatus, and when the second message transmitted by an access point different from said access point transmitting said second message received previously is received subsequently, said relay node judges whether or not the relay node itself is a crossover node to converge said second message based on specified information of received said second message, and in case it is judged as said crossover node, said relay node calculates QoS information of the optimal communication path between said mobile node and itself according to said specified information stored in said specified storage area and to said specified information of said second message received currently, and transmits a third message to acquire QoS information between itself and said communication apparatus;
a step where said crossover node calculates optimal QoS information in itself based on QoS information between the crossover node itself transmitted from said communication apparatus and said communication apparatus and on the calculated QoS information on the optimal communication path between said mobile node and itself, and transmits it to said specified access point; and
notifying step where said specified access point determines the optimal communication path based on QoS information received from a plurality of crossover nodes and notifies the access point to be connected to said mobile node.

38. The method for selecting attachment points according to claim 37, wherein said first message contains at least a plurality of types of address information of said communication apparatus, information of session ID generated by said mobile node, or information to generate session ID at an access point of transmission destination of said first message, information on number of said access points to become candidates of said connection, and information to indicate that said relay node performs specific operation because said communication apparatus has a plurality of interfaces.

39. The method for selecting attachment points according to claim 38, wherein said specified information contained in said second message comprises at least information of said session ID and information of flow ID generated according to address information of said access point to transmit said second message, information to indicate destination of said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path.

40. The method for selecting attachment points according to claim 39, wherein said relay node stores in said specified storage area, after the information to indicate said QoS information of said specified information contained in said second message has been updated, at least information of said session ID contained in said second message, information to indicate destination of said second message, information to indicate QoS information providable from said access point to said relay node, information to provide a path to correspond to the information to indicate said QoS information, information of flow ID of a message to indicate that it is for selection of the path, information on number of access points contained in said second message and transmitting said second message, and information on number of said second messages with the same session ID but different flow ID.

41. The method for selecting attachment points according to claim 40, wherein said relay node judges whether the relay node itself is said crossover node or not based on information of said session ID stored in said specified storage area and on information of session ID included in said second message received currently.

42. A method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication and having a plurality of interfaces, and one or more relay nodes positioned between said plurality of access points and said communication apparatus and capable to receive and to process the messages with a specified quality and transmitted and received between said mobile node and said communication apparatus, wherein said method comprises:
a transmitting step where said mobile node transmits a first message to request selection of said access point to be connected by the mobile node itself to each of the specified access points among said access points to become candidates of the connection;
a transmitting step where said specified access point, upon receipt of said first message, transmits a second message to request to transmit a third message including a specified information necessary for selection of said access point to be connected by said mobile node;
a transmitting step where said communication apparatus, upon receipt of said second message, transmits said third message to each of said access points to become candidates of said connection of the mobile node;
a transmitting step where said relay node, upon receipt of said third message, updates said specified information contained in said third message based on QoS level providable in itself, stores updated information in a specified storage area, and transfers said updated third message to said access points to become candidates of said connection, and in case the third message from a transmission source different from the transmission source of said third message previously received is received subsequently, said relay node judges whether the relay node itself is a crossover node to converge the messages or not based on said specified information of said received third message, and in case it is judged that it is said crossover node, the relay node calculates QoS information of the optimal communication path between the communication apparatus and itself based on said specified information stored in said specified storage area and on said specified information of said third message received currently, and transmits a fourth message to acquire QoS information between the relay node itself and said mobile node;
a step where said crossover node calculates the optimal QoS information on itself based on QoS information between itself transmitted from said mobile node and said mobile node and on said calculated QoS information of the optimal communication path between said communication apparatus and itself, and transmits it to said specified access point; and
a step where said specified access point determines the optimal communication path based on QoS information received from a plurality of crossover nodes and notifies the access points to be connected to said mobile node.

43. The method for selecting attachment points according to claim 42, wherein said first message contains at least a plurality of types of address information of said communication apparatus, information of session ID generated by said mobile node, or information to generate session ID at an access point of transmission destination of said first message, information on number of said access points to become candidates of said connection, address information of said access point to become candidates of said connection, and information to indicate data flow direction.

44. The method for selecting attachment points according to claim 43, wherein said second message contains at least a plurality of types of address information of said communication apparatus, information of session ID generated by said mobile node, or information to generate session ID to an access point of transmission destination of said first message, information on number of said access points to become candidates of said connection, and address information of said access points to become candidates of said connection.

45. The method for selecting attachment points according to claim 37, wherein:
when said mobile node has a plurality of interfaces:
said mobile node places into said first message information to indicate that said plurality of interfaces of said communication apparatus are used or information to indicate that said plurality of interfaces of the mobile node itself are used; and
said access point, upon receipt of said first message, places, into said second message, a flag to indicate that said plurality of interfaces of said communication apparatus are used by said communication apparatus itself or that said plurality of interfaces of said mobile node itself are used by said mobile node.

46. The method for selecting attachment points according to claim 42, wherein:
when said mobile node has a plurality of interfaces:
said mobile node places into said first message information to indicate that said plurality of interfaces of said communication apparatus are used or information to indicate that said plurality of interfaces of the mobile node itself are used;
said specified access point places, upon receipt of said first message, into said second message, information to indicate that said plurality of interfaces of said communication apparatus are used by said communication apparatus itself or said plurality of interfaces of said mobile node itself are used by said mobile node; and
said communication apparatus, upon receipt of said second message, places into said third message a flag to indicate that said communication apparatus uses said plurality of interfaces of the communication apparatus itself or to indicate that said mobile node uses said plurality of interfaces of the mobile node itself.

47. The method for selecting attachment points according to claim 1, wherein
in case said mobile node or said access point to become candidates of connection has IP address of said mobile node in advance after the connection to said access point; and
it is so arranged that said optimal communication path is determined and resource reservation is made to said optimal communication path.

48. A relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication and having a plurality of interfaces, and one or more relay nodes positioned between said plurality of access points and said communication apparatus and capable to receive and to process the messages with a specified quality transmitted and received between said mobile node and said communication apparatus, wherein said relay node comprises;
receiving means for receiving a second message containing a specified information necessary for selection of said access point to be connected by said mobile node based on a first message to request selection of said access point to be connected by said mobile node;
updating means for updating said specified information contained in said second message received via said receiving means based on QoS level providable by said relay node itself and storing in a specified storage area;
transfer means for transferring said updated second message to said communication apparatus;
judging means for judging whether or not the relay node itself is a crossover node to converge all of said second messages based on said specified information of the second message transmitted by a transmission source different from the transmission source of said second message previously received after the transfer of said updated second message; and
calculating means for calculating QoS information on optimal communication path between said mobile node and said relay node itself based on said specified information stored in said specified storage area and on said specified information of said second message received currently in case the relay node itself judges that it is in itself said crossover node by said judging means
message generating means for generating a third message to acquire QoS information between said relay node itself and said communication apparatus; and
said transfer means transmits said third message to said communication apparatus.

49. The relay node according to claim 48, wherein said first message contains at least a plurality of types of information of said communication apparatus, information of session ID generated by said mobile node, or information to generate session ID at an access point of transmission destination of said first message, and information on number of said access points to become candidates of said connection.

50. The relay node according to claim 49, wherein said specified information contained in said second message comprises at least information of said session ID, information of flow ID generated according to address information of said access point to transmit said second message, information to indicate destination of said second message, information to indicate a request to select an optimal communication path between said mobile node and said communication apparatus, information on number of said access points to transmit said second message, information used when said mobile node selects said access point to be connected, and information to indicate QoS information as updatable at said relay node on the path where said second message passes and providable on said path.

51. The relay node according to claim 50, wherein said updating means stores in said specified storage area, after the information to indicate said QoS information of said specified information contained in said second message has been updated, at least information of said session ID contained in said second message, information to indicate destination of said second message, information to indicate QoS information providable from said access point to said relay node, information to provide a path to correspond to the information to indicate said QoS information, information of flow ID of the message to indicate that it is path selection, information on number of access points transmitting said second message contained in said second message, and information on number of said second messages with the same session ID but different flow ID.

52. The relay node according to claim 51, wherein said judging means judges whether the relay node itself is said crossover node or not based on information of said session ID stored in said specified storage area and on information of session ID contained in said second message received currently.

53. A relay node used in a method for selecting attachment points to select access points to be connected when a mobile node performs communication with a communication apparatus in a communication system, said system comprising a plurality of access points, each forming a specific communicable area, said communication apparatus, being a correspondent node of a mobile node performing communication with said access points via wireless communication and having a plurality of interfaces, and one or more relay nodes positioned between said plurality of access points and said communication apparatus and capable to receive and to process the messages with a specified quality transmitted and received between said mobile node and said communication apparatus, wherein said relay node comprises;
receiving means for receiving a first message containing a specified information necessary for selection of said access point to be connected by said mobile node;
updating means for updating said specified information contained in said first message received via said receiving means based on QoS level providable by said relay node itself, and for storing it in a specified storage area;
transfer means for transferring said updated first message to said access point to become candidate of said connection;
judging means for judging whether the relay node itself is a crossover node to converge the message based on said specified information of said received first message in case a first message is received, which has been transmitted from a transmission source different from the transmission source of said first message received previously after the transfer of said updated first message;
calculating means for calculating QoS information on the optimal communication path between said communication apparatus and the relay node itself based on said specified information stored in said specified storage area and on said specified information of said first message received currently in case it is judged by said judging means that the relay node itself is said crossover node;
message generating means for generating a second message to acquire QoS information between said relay node itself and said mobile node; and
said calculating means calculates optimal QoS information in said crossover node itself based on QoS information between said crossover node itself and said mobile node transmitted from said mobile node and on QoS information on the calculated optimal communication path between said communication apparatus and said crossover node itself; and
said transfer means transmits results of calculation obtained by said calculating means to a specified access point.

54. The relay node according to claim 48, wherein
in case said mobile node has a plurality of interfaces;
said receiving means receives said second message including a flag to indicate that said communication apparatus uses said plurality of interfaces of said communication apparatus itself or said mobile node uses said plurality of interfaces in a second message containing a specified information necessary for selection of said access point to be connected by said mobile node based on a first message to request selection of said access point to be connected by said mobile node.

55. The relay node according to claim 53, wherein
in case said mobile node has a plurality of interfaces;
said receiving means receives a first message including a flag to indicate that said communication apparatus uses said plurality of interfaces of said communication apparatus itself, or that the mobile node uses said plurality of interfaces in the first message including a specified information necessary for selection of said access point to be connected by said mobile node.
